(19) United States
(12) Patent Application Publication
(10) Pub. No.: US 2013/0102934 A1
(43) Pub. Date: Apr. 25, 2013

(54) MOTION ASSIST DEVICE AND WALKING ASSIST DEVICE

(71) Applicant: HONDA MOTOR CO., LTD., Tokyo (JP)

(72) Inventor: Yasushi Ikeuchi, Wako-shi (JP)

(73) Assignee: HONDA MOTOR CO., LTD., Tokyo (JP)

(21) Appl. No.: 13/657,108

(22) Filed: Oct. 22, 2012

(30) Foreign Application Priority Data
Oct. 24, 2011 (JP) 2011-233267

(51) Int. Cl. A61H 3/00

(52) U.S. Cl. CPC A61H 3/00
USPC 601/35

(57) ABSTRACT

A walking assist device has rotational actuators that generate drive forces from electric energy supplied from batteries provided in right and left leg links. If there is a difference in the SOCs of the batteries of the two leg links, then a controller controls the rotational actuators such that the drive force of the rotational actuator corresponding to a battery having a lower SOC is smaller than the drive forces of the rotational actuators in the case where the SOCs of the two batteries are the same, while the drive of the rotational actuator corresponding to a battery having a higher SOC is larger than the drive forces of the rotational actuators in the case where the SOCs of the two batteries are the same.

### BACKGROUND OF THE INVENTION

1. Field of the Invention

The present invention relates to a motion assist device adapted to assist a user with his/her motion and a walking assist device adapted to assist the user with his/her walking.

2. Description of the Related Art

Hitherto, there has been known a walking assist device provided with right and left hip joint actuators, which are installed to the abdominal part of a walker to impart assist forces around hip joints, right and left knee joint actuators, which are installed to the knees of the walker to impart assist forces around knee joints, and a battery that supplies electric energy to the right and left hip joint actuators and the right and left knee joint actuators (Japanese Patent Publication No. 4060573). The user of the walking assist device, i.e., the walker, carries on his/her back a backpack in which the battery is stored.

However, the walking assist device described above requires wiring for supplying the electric energy from the battery stored in the backpack to the hip joint actuators and the knee joint actuators. Generally, in order to ensure stable supply of electric power, the wiring for supplying electric energy is formed to be thicker than, for example, signal wires for transferring data. This has been posing a problem in that the wiring set between the battery in the backpack and each actuator, as in Japanese Patent Publication No. 4060573, inevitably involves a complicated arrangement.

A possible solution may be a battery installed to each actuator. However, all actuators do not output the same level of force, i.e., the force output from each actuator differs, depending on a situation. This means that the amount of electricity consumed by each actuator is different. In addition, the degree of deterioration of each battery is different. Therefore, in the case where a plurality of batteries is mounted, the remaining amount of charge (the state of charge (SOC)) of each battery may vary due to a change in consumed electric power, the deterioration of a battery, or the like.

Proper forces output from all actuators enable the walking assist device to properly perform walking assist. For this reason, the walking assist device should suspend performing the walking assist if any one of the actuators becomes incapable of outputting a force. Therefore, if the walking assist device has each actuator provided with a battery, then the walking assist is desirably stopped when the remaining amount of charge of any one battery reduces to zero (or a value close to zero). In this case, the walking assist device suspends the walking assist even when the remaining amounts of charge of many other batteries are not zero, thus inconveniently resulting in less time of usability.

This is a problem not only with the walking assist device but also with all motion assist devices for assisting the users with their motions.

### SUMMARY OF THE INVENTION

In view of the background described above, an object of the present invention is to provide a motion assist device adapted to restrain the time of usability from reducing due to variation in the energy remaining amount of each energy source (e.g., the remaining amount of charge) in the case where the device has a plurality of energy sources (e.g., batteries).

A motion assist device according to the present invention is adapted to assist a user with his/her motions, and comprises: a plurality of drivers configured to generate forces for assisting a motion of a user; a plurality of energy sources that supplies energy to the plurality of the drivers; a remaining amount detector configured to detect an energy remaining amount of each of the energy sources; and a controller configured to control the plurality of the drivers on the basis of a detection result of the remaining amount detector, wherein the plurality of the drivers is configured such that an operating point of each generated force lies in the same part of the user, and in the case where one or a plurality of drivers to which energy is supplied from the same energy source among the plurality of the drivers constitute one drive source, and an output or outputs of one or a plurality of the drivers belonging to the drive source are defined as an output of the drive source, the controller controls the plurality of the drivers, in the case where there is a difference in the energy remaining amount among the energy sources, such that the drive source corresponding to an energy source having a small energy remaining amount generates a smaller output than an output of the drive source in the case where the energy remaining amounts of the energy sources are equal, while the driver source corresponding to an energy source having a large energy remaining amount generates a larger output than an output of the drive source in the case where the energy remaining amounts of the energy sources are equal.

According to the present invention, if there is a difference in the energy remaining amount among the energy sources, then the controller controls the plurality of drivers such that a drive source corresponding to an energy source having a small energy remaining amount generates a smaller force whereas a drive source corresponding to an energy source having a large energy remaining amount generates a larger force, as compared with the forces generated by the drive sources in the case where the energy remaining amounts of the energy sources are the same. This means that, as compared with the case where the energy remaining amounts of the energy sources are the same, the power consumption of a drive source corresponding to an energy source having a smaller energy remaining amount will be lower, whereas the power consumption of a drive source corresponding to an energy source having a larger energy remaining amount will be higher.

Thus, each driver is controlled by the controller such that the difference in the energy remaining amount among the energy sources is decreased. Hence, when the energy remaining amount of any one of the energy sources reaches zero (or a value close to zero), the energy remaining amounts of other energy sources will be also zero (or values close to zero). This enables the motion assist device according to the present invention to restrain the operating time from decreasing due to variation in the energy remaining amounts of the energy sources in the case where the device has a plurality of energy sources.

Herein, the state in which there is a difference in energy remaining amount in the present invention will refer only to a state in which there is a certain degree of difference that makes it possible to determine whether the forces output by a plurality of drivers are required to be controlled on the basis of energy remaining amounts rather than referring to any states other than the one in which the energy remaining amounts are exactly the same.

A walking assist device according to the present invention includes: a seat member on which a user sits astride; a plurality of leg links connected to the seat member; and a driver configured to be capable of driving the leg links in a direction for pushing the seat member up, at least a part of the weight of the user being supported by the leg links through the intermediary of the seat member, wherein the walking assist device includes a plurality of drivers, each of the drivers driving a single or two or more of the plurality of the leg links, a plurality of batteries which supplies electric energy to a single or two or more of the plurality of the drivers; a remaining amount detector configured to detect a remaining amount of charge of each battery; and a controller configured to control the plurality of the drivers on the basis of a detection result of the remaining amount detector, and in the case where one or a plurality of the drivers to which electric energy is supplied from the same battery among the plurality of the drivers constitutes one drive source, and an output or outputs of one or a plurality of the drivers belonging to the drive source are defined as an output or outputs of the drive source, the controller controls the plurality of the drivers, in the case where there is a difference in the remaining amount of charge among the batteries, such that the drive source corresponding to a battery having a small remaining amount of charge generates a smaller output than an output of the drive source in the case where the remaining amounts of charge of the batteries are equal, while the driver source corresponding to a battery having a large remaining amount of charge generates a larger output than an output of the drive source in the case where the remaining amounts of charge of the batteries are equal.

According to the walking assist device of the present invention, if there is a difference in the remaining amount of charge among the batteries, then the controller controls the plurality of drivers such that a drive source corresponding to a battery having a small remaining amount of charge generates a smaller force, whereas a drive source corresponding to a battery having a large remaining amount of charge generates a larger force, as compared with a force generated by a drive source in the case where the remaining amounts of charge of the batteries are equal. This means that, as compared with the case where the remaining amounts of charge of the plurality of batteries are equal, the power consumption of a drive source corresponding to a battery having a small remaining amount of charge will be lower, whereas the power consumption of a drive source corresponding to a battery having a large remaining amount of charge will be higher.

Thus, each drive source is controlled by the controller such that the difference in the remaining amount of charge among the batteries is decreased. Hence, when the remaining amount of charge of any one of the batteries reaches zero (or a value close to zero), the remaining amounts of charge of other batteries will be also zero (or values close to zero). This enables the walking assist device according to the present invention to restrain the operating time from decreasing due to variation in the remaining amounts of the batteries in the case where the device has a plurality of batteries.

Herein, the state in which there is a difference in the remaining amount of charge in the present invention will refer only to a state in which there is a degree of difference that makes it possible to determine whether the forces output by a plurality of drivers are required to be controlled on the basis of the remaining amounts of charge rather than referring to any states other than the one in which the remaining amounts of charge are exactly the same value.

In the walking assist device according to the present invention, as the difference in the remaining amount of charge between predetermined two batteries among the plurality of batteries increases, the controller preferably controls the two drive sources corresponding to the predetermined two batteries such that the difference in the electric energy supplied to the two drive sources increases. This makes it possible to decrease the difference in the remaining amount of charge between the batteries more promptly.

In the walking assist device according to the present invention, as the state in which there is a difference in the remaining amount of charge between predetermined two batteries among the plurality of batteries lasts longer, the controller preferably controls the two drive sources corresponding to the predetermined two batteries such that the difference in the electric energy supplied to the two drive sources increases. This makes it possible to decrease the difference in the remaining amount of charge between the batteries more promptly.

In the walking assist device according to the present invention, as the time-dependent change amount of a difference in the remaining amount of charge between predetermined two batteries among the plurality of batteries increases, the controller preferably controls the two drive sources corresponding to the predetermined two batteries such that the difference in the electric energy supplied to the two drive sources increases. This makes it possible to decrease the difference in the remaining amount of charge between the batteries more promptly.

In the walking assist device according to the present invention, in the case where one or a plurality of the drivers corresponding to the drive source drives one or the plurality of the leg links and in the case where a force by which each leg link pushes the seat member up or a force combining individual forces is defined as a leg link resultant force, the controller preferably controls predetermined two drive sources among the plurality of the drive sources such that the difference in the electric energy supplied to the predetermined two drive sources decreases as the angle formed by the individual leg link resultant forces increase.

If there is no difference in the forces between the two drive sources, then the forces are transmitted in the same direction regardless of the angle formed by the leg link resultant forces of the two drive sources. Meanwhile, if there is a difference in the forces between the two drive sources, then the direction of the resultant force of the two leg link resultant forces significantly changes as the angle formed by the leg link resultant forces of the two drive sources increases. If the direction of the resultant force of the two leg link resultant forces changes, then the direction of the force for pushing the seat member up also changes, possibly causing the user to feel uncomfortable.

Thus, the controller controls the plurality of the drivers such that the difference in the electric energy supplied to the two drive sources decreases as the angle formed by the two leg link resultant forces increases, thereby decreasing a change in the direction of the resultant force of the two leg link resultant forces. This makes it possible to reduce uncomfortable feeling of the user.

In the walking assist device according to the present invention, if the difference in the remaining amount of charge of predetermined two batteries among the plurality of the batteries is a predetermined value or more, then the controller preferably controls the plurality of the drivers on the basis of a detection result of the remaining amount detector.

A force output from a driver is frequently biased, depending on an operation situation. In this case, a difference in the remaining amount of charge tends to occur among batteries. An attempt to immediately reduce a force to be generated in response to a frequently occurring event tends to cause the user to feel uncomfortable. To obviate this, the controller reduces a force to be generated only when the difference in the remaining amount of charge between two batteries is a predetermined value or more, thus permitting improved convenience for the user.

### BRIEF DESCRIPTION OF THE DRAWINGS

FIG. 1 is a perspective view of a walking assist device according to an embodiment of the present invention;

FIG. 2 is a side view of the walking assist device according to the embodiment;

FIG. 3 is a front view of the walking assist device according to the embodiment;

FIG. 4 is a cut side view of a thigh frame of the walking assist device according to the embodiment;

FIG. 5 is a diagram illustrating an angle of spread legs of the walking assist device according to the embodiment;

FIG. 6 is a block diagram illustrating a processing flow of a controller according to the embodiment;

FIG. 7 is a diagram illustrating a relationship between a right/left tread force ratio and a sharing ratio in the case where the remaining amounts of charge of the batteries of a left leg link and a right leg link are equal;

FIG. 8 illustrates a relationship between the right/left tread force ratio and the sharing ratio in a case where there is a difference in the remaining amount of charge between the batteries of the left leg link and the right leg link, respectively, FIG. 8A illustrating a case where a measured tread force of the left leg link is larger than that of the right leg link and FIG. 8B illustrating a case where a measured tread force of the left leg link is smaller than that of the right leg link;

FIG. 9 is a flowchart illustrating the processing of a right/left desired share determiner illustrated in FIG. 6;

FIG. 10 is a graph illustrating a relationship between a leg spread angle and a gain of a manipulated variable;

FIG. 11 is a block diagram illustrating a processing function of an instructed current determiner illustrated in FIG. 6;

FIG. 12 is a view illustrating the processing of a basic desired torque calculator illustrated in FIG. 11;

FIGS. 13A and 13B illustrate a relationship between the right/left tread force ratio and the sharing ratio in another embodiment, which is different from the one illustrated in FIG. 8, in a case where there is a difference in the remaining amount of charge between the battery of the left leg link and the battery of the right leg link, respectively; and

FIGS. 14A and 14B illustrate a relationship between the right/left tread force ratio and the sharing ratio in another embodiment, which is different from the ones illustrated in

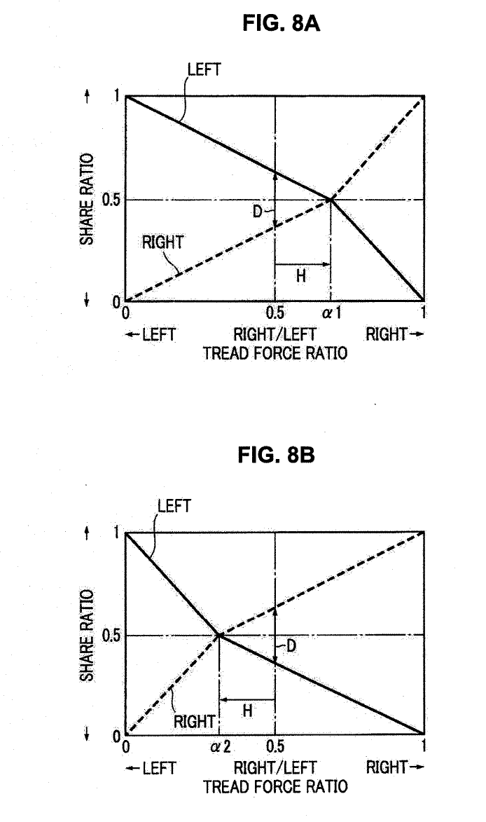

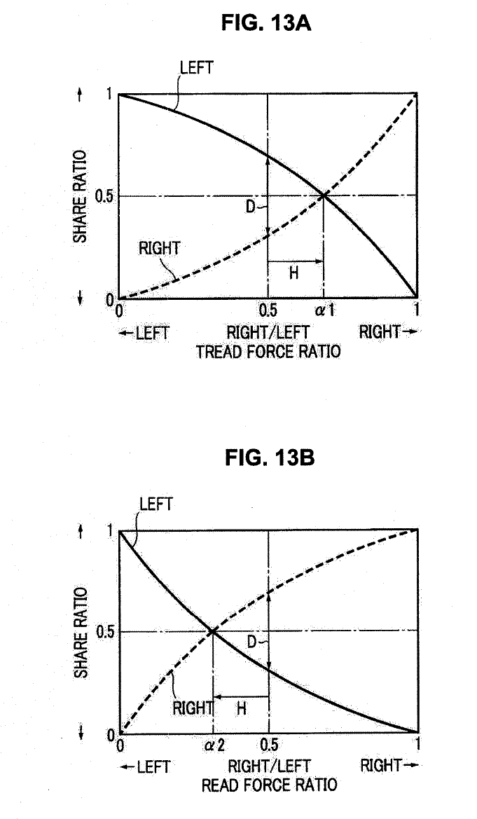

FIG. 8 and FIGS. 13A and 13B, in a case where there is a difference in the remaining amount of charge between the battery of the left leg link and the battery of the right leg link.

### DESCRIPTION OF THE PREFERRED EMBODIMENTS

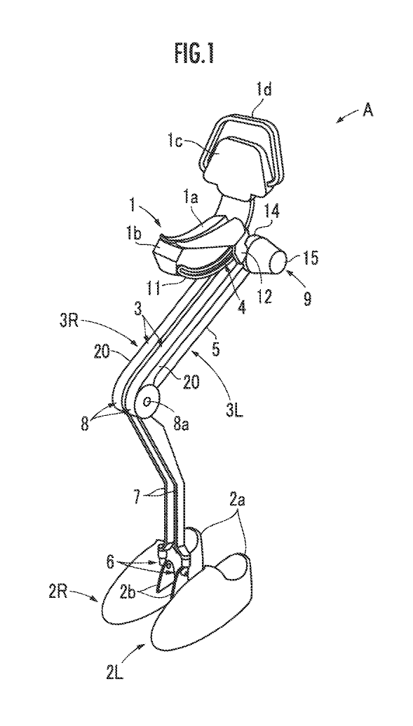

An embodiment of the present invention will be described below. Referring to FIG. 1 to FIG. 4, the mechanical construction of a walking assist device according to the present embodiment will be described first.

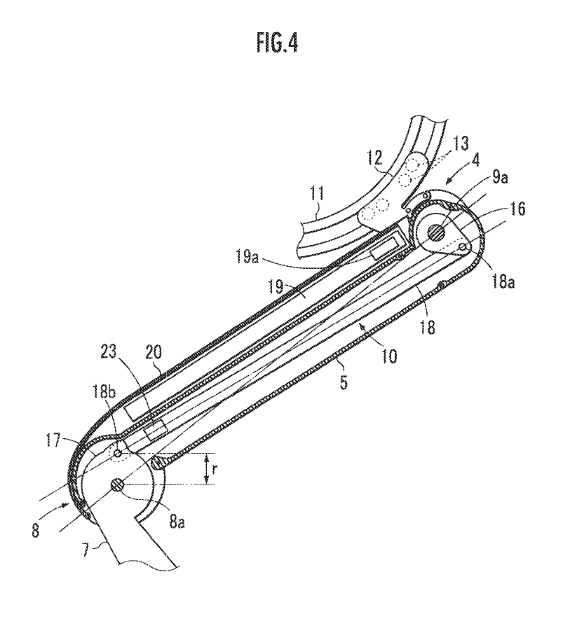

FIG. 1 to FIG. 3 are a perspective view, a side view, and a front view, respectively, illustrating the appearance of the walking assist device according to the present embodiment, and FIG. 4 is a cut side view of a thigh frame of the walking assist device.

As illustrated, a walking assist device A according to the present embodiment has a seat member 1 on which a user P sits, a pair of right and left foot-worn units 2R and 2L attached to the feet of the legs of the user P, and a pair of right and left leg links 3R and 3L that connect the foot-worn units 2R and 2L to the seat member 1. The right and left foot-worn units 2R and 2L have the same construction, being laterally symmetrical to each other. The right and left leg links 3R and 3L also have the same construction, being laterally symmetrical to each other.

In the following description, of the right and left leg links 3R and 3L, the leg link on the right side, which is observed from the front of the user P, will be referred to as the right leg link 3R, and of the right and left leg links 3R and 3L, the leg link on the left side, which is observed from the front of the user P, will be referred to as the left leg link 3L. Further, of the right and left foot-worn units 2R and 2L, the foot-worn unit on the right side, which is observed from the front of the user P, will be referred to as the right foot-worn unit 2R, and of the right and left foot-worn units 2R and 2L, the foot-worn unit on the left side, which is observed from the front of the user P, will be referred to as the left foot-worn unit 2L. The following description will mainly focus on the left leg link 3L and the left foot-worn unit 2L of the walking assist device A.

In the following description, characters “R” and “L” may be added to the ends of reference numerals to distinguish between the right and the left. The characters “R” and

“L” at the ends of reference numerals will be used to mean the association with the right leg link 3R and the left leg link 3L.

Each of the leg links, 3R and 3L, is constituted of a first joint 4, a thigh frame 5, a second joint 6, a crus frame 7, and a third joint 8. The thigh frame 5 is extended downward from the seat member 1 through the intermediary of the first joint 4. The crus frame 7 is extended upward from the foot-worn unit 2R or 2L through the intermediary of the second joint 6. The third joint 8 stretchably connects the thigh frame 5 and the crus frame 7 at the middle between the first joint 4 and the second joint 6.

Further, each of the leg links 3R and 3L of the walking assist device A is provided with a rotational actuator 9 serving as a driver and a motive power transmitting mechanism 10. The rotational actuator 9 generates a drive force for driving the third joint 8. The motive power transmitting mechanism 10 transmits the drive force of the rotational actuator 9 to the third joint 8 so as to impart a drive torque about the axis of the third joint 8.

The seat member 1 is constituted of a saddle-shaped seat 1a disposed such that the seat la is positioned between the proximal ends of the two legs of the user P when the user P sits thereon astride, a support frame 1b attached to the bottom surface of the seat 1a, and a hip pad 1c attached to the rear end portion of the support frame 1b (the portion that rises upward at rear of the seat 1a). An arched handle Id that can be held by the user P or an assistant is attached to the hip pad 1c.

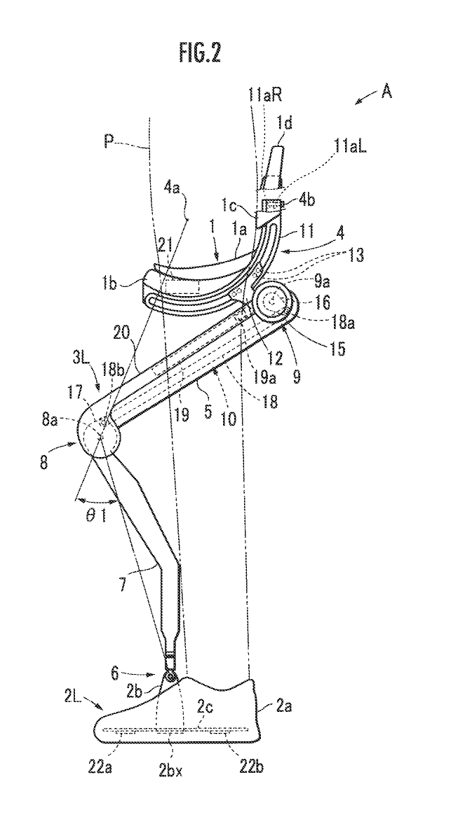

The first joint 4 of each of the leg links 3R and 3L is a joint which has a freedom degree (2 degrees of freedom) of rotation about two joint axes in a longitudinal direction and a lateral direction. More specifically, each of the first joints 4 has an arcuate guide rail 11 attached to the seat member 1. A slider 12, which is secured to the upper end of the thigh frame 5 of each of the leg links 3R and 3L, movably engages the guide rail 11 through the intermediary of a plurality of rollers 13 rotatively attached to the slider 12. This arrangement enables each of the leg links 3R and 3L to effect a swing motion in the longitudinal direction (a longitudinal swing-out motion) about the axis of the first joint, taking the lateral axis, which passes a curvature center 4a of the guide rail 11 (refer to FIG. 2) and which is perpendicular to a plane including the arc of the guide rail 11, as a first joint axis of the first joint 4.

Further, the guide rail 11 is rotatively supported at the rear end (the rising portion) of the support frame 1b of the seat member 1 through the intermediary of a support shaft 4b having the axial center thereof oriented in the longitudinal direction, thus enabling the guide rail 11 to swing about the axial center of the support shaft 4b. This arrangement allows each of the leg links 3R and 3L to effect a lateral swing motion, i.e., adduction/abduction motion, about a second joint axis, taking the axial center of the support shaft 4b as the second joint axis of the first joint 4. In the present embodiment, the second joint axis of the first joint 4 provides a joint axis common to the first joint 4 of the right leg link 3R and the first joint 4 of the left leg link 3L.

As described above, the first joint 4 is adapted to allow each of the leg links 3R and 3L to implement swing motions about the two joint axes, i.e., in the longitudinal direction and the lateral direction.

The degree of the rotational freedom of the first joint is not limited to two. Alternatively, the first joint may be constructed to have, for example, a freedom degree of rotation about three joint axes, i.e., three degrees of freedom. Further alternatively, the first joint may be adapted to have, for example, a freedom degree of rotation about only one joint axis in the lateral direction, i.e., one degree of freedom.

The left foot-worn unit 2L has a shoe 2a for the user P to put his/her foot therein and a connecting member 2b projecting upward from inside the shoe 2a. Each leg of the user lands on the ground through the shoe 2a in a state wherein the leg of the user P is a standing leg, i.e., a supporting leg. The lower end of the crus frame 7 of each of the leg links 3R and 3L is connected to the connecting member 2b via the second joint 6. In this case, the connecting member 2b has, as an integral part thereof, a flat-plate-like portion 2bx disposed under an insole 2c in the shoe 2a (between the bottom of the shoe 2a and the insole 2c), as illustrated in FIG. 2.

The connecting member 2b, including the flat-plate-like portion 2bx, is formed of a member having relatively high rigidity such that, when the left foot-worn unit 2L is landed, a part of a floor reaction force acting from a floor onto the left foot-worn unit 2L (a translational force which is large enough to support the weight combining at least the walking assist device A and a part of the weight of the user P) can be applied to the leg links 3L and 3R through the intermediary of the connecting member 2b and the second joint 6.

The left foot-worn unit 2L may have, for example, slipper-like footwear in place of the shoe 2a.

The second joint 6 in the present embodiment is constituted of a free joint, such as a ball joint, and has a freedom degree of rotation about three axes. Alternatively, the second joint 6 may be a joint having a freedom degree of rotation about, for example, two axes in the longitudinal and lateral directions or two axes in the vertical and lateral directions.

The third joint 8 is a joint having a freedom degree of rotation about one axis in the lateral direction and has a support shaft 8a, which is located at the lower end of the thigh frame 5 and which rotatably supports the upper end of the crus frame 7. The axial center of the support shaft 8a is substantially parallel to the first joint axis of the first joint 4. The axial center of the support shaft 8a serves as the joint axis of the third joint 8, and the crus frame 7 can be relatively rotated about the joint axis with respect to the thigh frame 5. This allows the leg links 3R and 3L to stretch and bend at the third joint 8.

The rotational actuator 9 for each of the leg links 3R and 3L is a rotational actuator constituted of an electric motor 15 provided with a speed reducer 14. The rotational actuator 9 is mounted on the outer surface of an upper end portion (a portion adjacent to the first joint 4) of the thigh frame 5 such that the axial center of an output shaft 9a is parallel to the joint axis of the third joint 8 (the axial center of the support shaft 8a). The housing of the rotational actuator 9 (a portion fixed to a stator of the electric motor 15) of the rotational actuator 9 is fixedly installed to the thigh frame 5.

Each of the motive power transmitting mechanisms 10 in the present embodiment is constituted of a drive crank arm 16, a driven crank arm 17, and a connecting rod 18.

The drive crank arm 16 is concentrically fixed to the output shaft 9a of the rotational actuator 9. The driven crank arm 17 is fixed to the crus frame 7 concentrically with the joint axis of the third joint 8. The connecting rod 18 has one end thereof pivotally attached to the drive crank arm 16 and the other end thereof pivotally attached to the driven crank arm 17. The connecting rod 18 linearly extends between a pivotal portion 18a for the drive crank arm 16 and a pivotal portion 18b for the driven crank arm 17.

In the motive power transmitting mechanism 10 constructed as described above, a drive force (output torque) output from the output shaft 9a of the rotational actuator 9 run by the electric motor 15 is converted into a translational force in the lengthwise direction of the connecting rod 18 through the drive crank arm 16 from the output shaft 9a, and the translational force (rod transmitting force) is transmitted along the connecting rod 18 in the lengthwise direction thereof. Further, the translational force is converted into a drive torque through the driven crank arm 17 from the connecting rod 18, and the drive torque is imparted to the third joint 8 as a drive force for stretching/bending each of the leg links 3R and 3L about the joint axis of the third joint 8.

Herein, according to the present embodiment, the sum of the lengths of the thigh frame 5 and the crus frame 7 of each of the leg links 3R and 3L is set to be greater than the length of a leg of the user P when the leg is linearly stretched. Therefore, each of the leg links 3R and 3L always bends at the third joint 8. A bending angle θ1 (refer to FIG. 2) is an angle ranging from, for example, approximately 40° to 70° during normal walking of the user P on a flat ground. The bending angle θ1 in this case means an angle (angle on an acute angle side) formed by a straight line connecting the third joint 8 and the curvature center 4a of the guide rail 11 and a straight line connecting the third joint 8 and the second joint 6 when the leg links 3R and 3L are observed in the direction of the joint axis of the third joint 8, as illustrated in FIG. 2.

Further, according to the present embodiment, the relative positional relationship among the pivotal portions 18a, 18b of the connecting rod 18, the supporting shaft 8a of the third joint 8, and the output shaft 9a of the rotational actuator 9 is set such that the drive torque imparted to the third joint 8 is greater than the output torque of the rotational actuator 9 in a state wherein the bending angle θ1 of each of the leg links 3R and 3L falls in a certain angle range (e.g., a range from approximately 20° to 70°), including the angle range of the normal walking of the user P on a flat ground. In this case, according to the present embodiment, when each of the leg links 3R and 3L is observed in the direction of the joint axis of the third joint 8, the straight line connecting the output shaft 9a of the rotational actuator 9 and the supporting shaft 8a of the third joint 8 and the straight line connecting the pivotal portion 18a of the connecting rod 18 and the pivotal portion 18b thereof obliquely cross each other, as illustrated in FIG. 4.

Further, according to the present embodiment, the position of the pivotal portion 18b of the connecting rod 18 is set such that the drive torque imparted to the third joint 8 will be a torque that urges the leg links 3R and 3L in a stretching direction in the case where a tensile force in the lengthwise direction of the connecting rod 18 is applied to the connecting rod 18 from the rotational actuator 9 in the state wherein the bending angle θ1 of each of the leg links 3R and 3L falls in a certain angle range (e.g., a range from approximately 20° to 70°, including the angle range of the normal walking of the user P on a flat ground. In this case, according to the present embodiment, when the leg links 3R and 3L are observed in the direction of the joint axis of the third joint 8, the pivotal portion 18b of the connecting rod 18 is provided closer to the guide rail 11 than to the straight line connecting the output shaft 9a of the rotational actuator 9 and the supporting shaft 8a of the third joint 8.

Further, as illustrated in FIG. 4, the thigh frame 5 has a battery 19 and a cover 20 attached thereto. The battery 19 is disposed between the connecting rod 18 and the guide rail 11. The cover 20 is formed, covering the battery 19, and attached to the thigh frame 5. Thus, in the present embodiment, the battery 19 is provided for each of the leg links 3R and 3L.

The battery 19, which is a rechargeable secondary battery, functions as the power source for electric components, such as the electric motors 15. These batteries 19 are electrically connected to the rotational actuators 9 through electric wiring (not shown).

More specifically, the battery 19 disposed in the thigh frame 5 of the left leg link 3L is adapted to serve as a power source supplying electric energy to the rotational actuator 9, which generates a drive force for driving the third joint 8 of the left leg link 3L.

Similarly, the battery 19 disposed in the thigh frame 5 of the right leg link 3R is adapted to serve as a power source supplying electric energy to the rotational actuator 9, which generates a drive force for driving the third joint 8 of the right leg link 3R.

Thus, the battery 19 disposed in each of the leg links 3R and 3L supplies electric energy to the rotational actuator 9 according to the leg link (3R or 3L) in which the battery 19 is disposed.

The batteries 19 correspond to the batteries and the energy sources in the present invention. The remaining amounts of charge or SOC of the batteries 19 correspond to the remaining amounts of charge and the remaining amounts of energy in the present invention. As the batteries, a capacitor, such as an electric double layer capacitor (including one that combines a plurality of capacitor elements) may be used as long as it is capable of storing a sufficient amount of electric energy that secures a sufficiently long operating time of the walking assist device A. Alternatively, the battery may be constituted by combining a battery and a capacitor.

The batteries 19 are disposed in the leg links 3R and 3L, and each of the batteries 19 supplies electric energy to the rotational actuator 9 of the leg link 3R or 3L in which the battery 19 is disposed. This corresponds to “energy is supplied to a drive source from the same energy source among a plurality of drivers” and also corresponds to “electric energy is supplied to a drive source from the same battery among a plurality of drivers” in the present invention.

According to the present embodiment, the rotational actuator 9 of each of the leg links 3R and 3L is electrically connected to a single battery 19 for a single rotational actuator 9. In other words, the single battery 19 is electrically connected to the single rotational actuator 9 corresponding thereto. More specifically, according to the present embodiment, the rotational actuator 9 of the left leg link 3L alone corresponds to one drive source in the present invention, and the drive force of the rotational actuator 9 of the left leg link 3L corresponds to an output of the drive source in the present invention. If the single battery 19 supplies electric energy to a plurality of rotational actuators 9, then the rotational actuators 9 will correspond to the drive source in the present invention.

The above has described the mechanical major configuration of the walking assist device A according to the present embodiment. In the walking assist device A constituted as described above, a drive force (drive torque) in the stretching direction is imparted to the third joints 8 of the leg links 3R and 3L from the rotational actuators 9 through the motive power transmitting mechanisms 10 in a state wherein the foot-worn units 2R and 2L are in contact with a ground, thereby urging the seat member 1 upward. This causes an upward lifting force to be applied to the user P from the seat member 1. The walking assist device A according to the present embodiment supports a part of the weight of the user P (a part of the gravity acting on the user P) by the lifting force so as to reduce a burden on the legs when the user P walks.

In the present embodiment, the drive force of the rotational actuator 9 acting on the user P through the intermediary of the seat member 1 corresponds to “at least a part of the weight of the user being supported by a leg link through the intermediary of a seat member” and also corresponds to “a plurality of drivers being configured such that the operating point of each generated force lies on the same part of the user” in the present invention.

In this case, of a support force for supporting all the walking assist device A and the user P on a floor, i.e., a total translational force applied from a floor to a ground surface with which the walking assist device A is in contact (hereinafter referred to as “the total support force”), the support force for supporting the walking assist device A itself and a part of the weight of the user P on a floor will be borne by the walking assist device A, whereas the remaining support force will be borne by the user P. Hereinafter, of the aforesaid total support force, the support force borne by the walking assist device A will be referred to as the assist device borne support force, while the support force borne by the user P will be referred to as the user borne support force.

The assist device borne support force will dividedly act on both the right and left leg links 3R and 3L in a state wherein both legs of the user P are standing legs, or will act on the leg link of only one of the two leg links 3R and 3L in a state wherein only one leg is a standing leg. The same applies to the user borne support force.

In the present embodiment, a spring (not shown) for urging each of the leg links 3R and 3L in the stretching direction is attached to the third joint 8 of each of the leg links 3R and 3L or between the thigh frame 5 and the crus frame 7 to reduce a load on the rotational actuator 9, i.e., to reduce a required maximum output torque. The spring may, however, be omitted.

A description will now be given of the configuration for controlling the operation of the walking assist device A according to the present embodiment. In the walking assist device A according to the present embodiment, a control unit 21 which controls the operation of each of the rotational actuators 9 is housed in the support frame 1b of the seat member 1, as illustrated in FIG. 2.

The control unit 21 is constituted of a microcomputer having a central processing unit (not shown), which carries out arithmetic processing, and a memory (not shown), which is a storage device for storing information. The memory stores and retains a program for executing the arithmetic processing by the central processing unit, data to which the program refers to (e.g., threshold values and tables), computation results and the like. The control unit 21 is further provided with an input interface (not shown) for entering information necessary for computation from outside and an output interface (not shown) for outputting command signals based on computation results to the outside.

The battery 19 has a battery management unit (BMU) 19a. The battery management unit 19a manages the state of the battery 19, including a SOC and a temperature. For example, the battery management unit 19a measures or detects the SOC by adding up the current flowing into the battery and the current flowing out of the battery. Thus, the battery management unit 19a in the present embodiment corresponds to the remaining amount detector in the present invention.

The battery management unit 19a controls the current flowing into or out of the battery 19 according to the state of the battery 19, including the SOC and the temperature detected as described above. The battery management unit 19a further outputs the SOC, the temperature or the like of the battery 19 as a communication signal to the outside.

The SOC of the battery 19 output from the battery management unit 19a is supplied as a communication signal to the control unit 21. The control unit 21 controls the operation of the electric motor 15 of the rotational actuator 9 on the basis of the received SOC of the battery 19. Herein, the control unit 21 corresponds to the controller in the present invention.

The method for measuring the SOC used by the battery management unit 19a is not limited to the one described above. For example, an internal resistance value may be estimated from a voltage across the terminals of the battery 19 (a voltage between a positive electrode and a negative electrode) and a current flowing in the battery 19 and then the SOC may be estimated or detected on the basis of the estimated internal resistance value.

Thus, in general, there are various known techniques for detecting the SOC of the battery 19, and any one of them may be used. The substantial remaining energy amount of the battery 19 is easily influenced by the temperature of the battery 19. In this case, the temperature of the battery 19 may be detected by a temperature sensor and corrective processing based on the detected temperature may be added to the processing for measuring the SOC.

The value of the SOC (the remaining amount of charge or the energy remaining amount) of the secondary battery described above is generally expressed in various modes, including the expression based on the dimension of energy (expression in units of [J], [W·h] or the like), the expression based on the dimension of charge amount (expression in units of [C], [A·h] or the like), or the expression based on a relative ratio with respect to a capacity value (rated capacity) when the battery 19 is fully charged (expression using percentage [%] or the like). The SOC in the present embodiment may be expressed by any one of the above, but will be expressed by the relative ratio [%] with respect to the rated capacity of the battery 19 in the following description for the sake of convenience.

The walking assist device A is further provided with a leg spread angle sensor 11a, a pair of force sensors 22a, 22b for measuring tread forces, a strain gauge force sensor 23, and an angle sensor 24 shown below.

The leg spread angle sensor 11a provided between the guide rail 11 and the support shaft 4b functions as an angle sensor which generates an output signal based on a relative rotational angle between the guide rail 11 and the support shaft 4b. In the following description, the leg spread angle sensor 11a provided on the left leg link 3L will be denoted by 11aL, while the one provided on the right leg link 3R will be denoted by 11aR. The support shaft 4b is a shaft common to the right and left leg links 3R and 3L. Hence, as illustrated in FIG. 2, the leg spread angle sensor 11aR of the right leg link 3R is disposed on the front side of the user P relative to the leg spread angle sensor 11aL of the left leg link 3L; however, the disposition of the leg spread angle sensors 11aR and 11aL of the right and left leg links 3R and 3L is not limited thereto, and either one of them may be positioned on the front side.

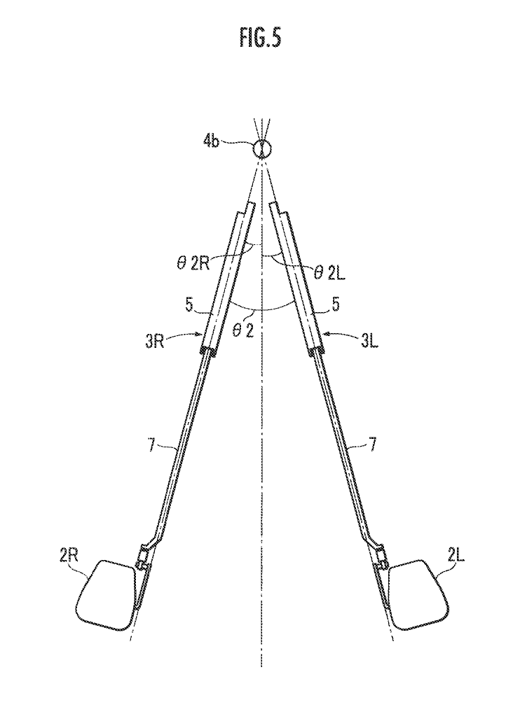

FIG. 5 is a schematic diagram of the walking assist device A observed from the front. The leg spread angle sensor 11aL of the left leg link 3L outputs an angle θ2L on an acute angle side formed by a perpendicular extending from the axial center of the support shaft 4b of the first joint 4 detected by a 3-axis acceleration sensor or the like serving as a gravitational direction detector (not shown) to the ground surface (a gravitational line of action) and an extended line of the central line in the lengthwise direction of the thigh frame 5 of the left leg link 3L (hereinafter referred to as “the left leg spread angle”). As illustrated in FIG. 5, the leg spread angle sensor 11aR of the right leg link 3R outputs an angle θ2R on an acute angle side formed by a perpendicular extending from the axial center of the support shaft 4b of the first joint 4 to the ground surface (a gravitational line of action) and an extended line of the central line in the lengthwise direction of the thigh frame 5 of the right leg link 3R (hereinafter referred to as “the right leg spread angle”).

According to the present embodiment, the crotch angle when the right and left legs are spread (hereinafter referred to as “the leg spread angle”) θ2 is defined as the angle (on the acute angle side) formed by the extended line of the central line in the lengthwise direction of the thigh frame 5 of the right leg link 3R and the extended line of the central line in the lengthwise direction of the thigh frame 5 of the left leg link 3L. In other words, the leg spread angle θ2 is expressed by “θ2=θ2R+θ2L.” Thus, the control unit 21 measures or detects the leg spread angle θ2 by a leg spread angle measuring unit 65, which will be discussed hereinafter, on the basis of the signals input from the leg spread angle sensors 11aR, 11aL of the right and leg links 3R and 3L, respectively.

In the present embodiment, the control unit 21 is adapted to detect the leg spread angle θ2 on the basis of the measurement or detection results of the leg spread angle sensors 11aR and 11aL of the right and left leg links 3R and 3L; however, the method for measuring or detecting the leg spread angle θ2 is not limited thereto, and any other method may be used as long as the method permits the measurement or detection of the leg spread angle θ2.

As illustrated in FIG. 2, the pair of the force sensors 22a and 22b for measuring tread forces are provided in the shoe 2a of the foot-worn units 2R and 2L, respectively, to measure the tread force of each leg of the user P (the translational force in the vertical direction for pressing the foot of each leg against a floor surface). The tread force of each leg is, in other words, a translational force that balances the force acting on each leg (the share of each leg) in the aforesaid user borne support force, and the magnitude of the sum of the tread forces of both legs is equal to the magnitude of the user borne support force. In the present embodiment, the tread force measuring force sensors 22a and 22b are attached to the bottom surface of the insole 2c in the shoe 2a at two places, front and back, namely, the place right below the metatarsophalangeal joint (MP joint) and a place right below the heel of the foot of the user P, such that they oppose the bottom surface of the foot of the user P. Each of the tread force measuring force sensors 22a and 22b is composed of a 1-axis force sensor and generates an output signal based on a translational force in a direction perpendicular to the bottom surface of the shoe 2a.

Further, as illustrated in FIG. 4, the strain gauge force sensor 23 serving as a sensor for measuring the rod transmitting force is installed on the connecting rod 18 of each of the motive power transmitting mechanisms 10 at a position adjacent to the third joint 8. The strain gauge force sensor 23 is a publicly known sensor composed of a plurality of strain gauges (not shown) secured to the outer peripheral surface of the connecting rod 18, and generates an output based on the translational force acting on the connecting rod 18 in the lengthwise direction thereof. The strain gauge force sensor 23 has high sensitivity to the translational force in the lengthwise direction of the connecting rod 18, while exhibiting sufficiently low sensitivity to a force in the shear direction (transverse direction) of the connecting rod 18.

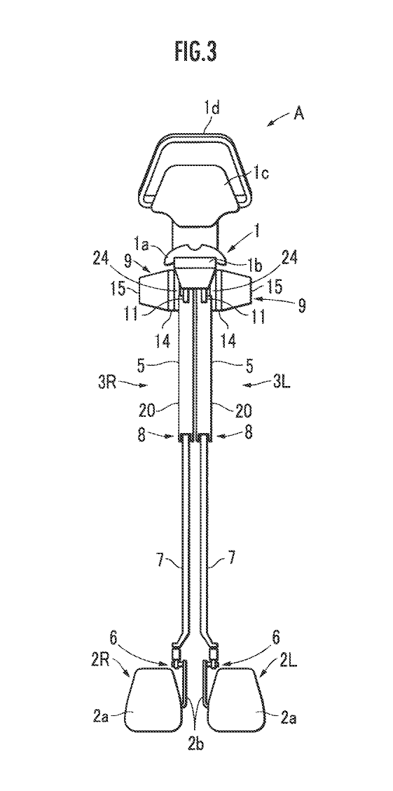

Installed on the thigh frame 5 integrally with the rotational actuator 9 is the angle sensor 24 (refer to FIG. 3), such as a rotary encoder, which generates an output based on a rotational angle (a rotational angle from a reference position) of the output shaft 9a of each of the rotational actuators 9. The angle sensor 24 measures a bending angle of each of the leg links 3R and 3L, which represent a displacement angle (a relative rotational angle of the crus frame 7 from a reference position in relation to the thigh frame 5) of the third joint 8 of each of the leg links 3R and 3L. According to the present embodiment, the bending angle at the third joint 8 of each of the leg links 3R and 3L is uniquely determined on the basis of the rotational angle of the output shaft 9a of each of the rotational actuators 9. Hence, the angle sensor 24 generates an output based on the bending angle of each of the leg links 3R and 3L. The third joint 8 of each of the leg links 3R and 3L corresponds to a knee joint, so that the bending angle of each of the leg links 3R and 3L at the third joint 8 will be referred to as the knee angle in the following description.

Supplementarily, an angle sensor, such as a rotary encoder, may be mounted on the third joint 8 of each of the leg links 3R and 3L so that the knee angle of each of the leg links 3R and 3L can be directly measured by the angle sensor.

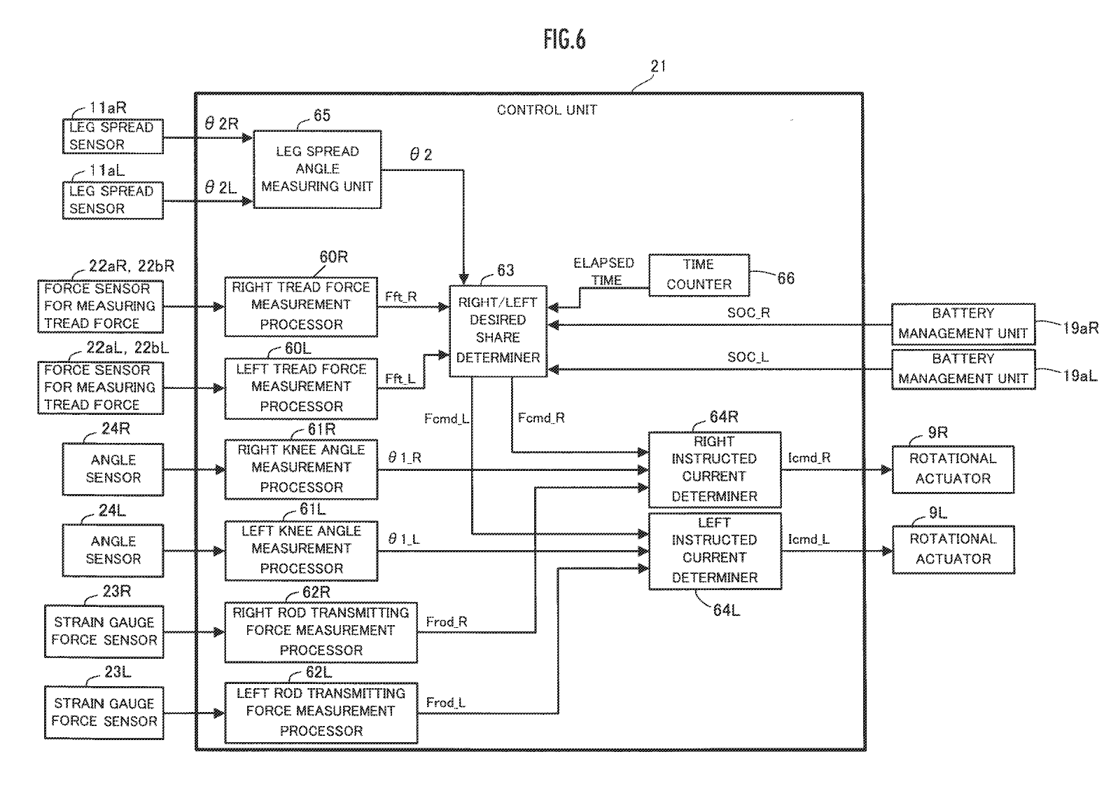

As illustrated in FIG. 6, the control unit 21 has a left tread force measurement processor 60L, which measures the tread force of the left leg of the user P on the basis of outputs of the tread force measuring force sensors 22a and 22b of the left foot-worn unit 2L (denoted by 22aL and 22bL in FIG. 6), a right tread force measurement processor 60R, which measures the tread force of the right leg of the user P on the basis of the outputs of the tread force measuring force sensors 22a and 22b of the right foot-worn unit 2R (denoted by 22aR and 22bR in FIG. 6), a left knee angle measurement processor 61L, which measures the knee angle of the left leg link 3L on the basis of an output of a left angle sensor 24L, a right knee angle measurement processor 61R, which measures the knee angle of the right leg link 3R on the basis of an output of a right angle sensor 24R, a left rod transmitting force measurement processor 62L, which measures a rod transmitting force acting on a connecting rod 18L of a motive power transmitting mechanism 10L (a translational force acting in the lengthwise direction of the connecting rod 18L) on the basis of an output of a left strain gauge force sensor 23L, a right rod transmitting force measurement processor 62R, which measures a rod transmitting force acting on a connecting rod 18R of a motive power transmitting mechanism 10R (a translational force acting in the lengthwise direction of the connecting rod 18R) on the basis of an output of a right strain gauge force sensor 23R, a leg spread angle measuring unit 65, which measures the leg spread angle θ2 on the basis of outputs of leg spread angle sensors 11aR and 11aL of the leg links 3R and 3L, respectively, and a time counter 66, which counts the elapsed time of control processing or the like.

The control unit 21 is further provided with a right/left desired share determiner 63, which determines desired values Fcmd_R and Fcmd_L of the shares of the assist device borne support force, the shares being borne by the leg links 3R and 3L. To determine the desired values Fcmd_R and Fcmd_L, the right/left desired share determiner 63 receives values of the right and left tread forces measured by the tread force measurement processors 60R and 60L (measured tread forces) Fft_R and Fft_L, detected remaining amounts of charge SOC_R and SOC_L detected by battery management units 19aR and 19aL, the leg spread angle θ2 measured by the leg spread angle measuring unit 65, and elapsed time counted by the time counter 66.

Supplementarily, the sum of the support forces acting on the leg links 3R and 3L from a floor side through the intermediary of the second joints 6 (hereinafter referred to as the total lifting force) is, to be more accurate, the value obtained by subtracting the support force for supporting the two foot-worn units 2R and 2L on a floor from the assist device borne support force. In other words, the total lifting force has a meaning as an upward translational force (assist force) that supports the walking assist device A, excluding the two foot-worn units 2R and 2L, and a part of the weight of the user P. However, the total weight of the two foot-worn units 2R and 2L is sufficiently smaller than the total weight of the walking assist device A, so that the total lifting force substantially agrees with the assist device borne support force.

In the following description, the share in the assist device borne support force assigned to the leg links 3R and 3L will be referred to as the total lifting force share. The desired values Fcmd_R and Fcmd_L of the total lifting force shares of the leg links 3R and 3L will be referred to as the leg link share desired values Fcmd_R and Fcmd_L. Further, the leg link share desired value Fcmd_L of the left leg link 3L will be referred to as the left share desired value Fcmd_L, while the leg link share desired value Fcmd_R of the right leg link 3R will be referred to as the right share desired value Fcmd_R.

The control unit 21 further includes a left instructed current determiner 64L and a right instructed current determiner 64R. The left instructed current determiner 64L determines an instructed current value Icmd_L of an electric motor 15L on the basis of a measured value Frod_L of the rod transmitting force of the connecting rod 18L measured by the left rod transmitting force measurement processor 62L and the left share desired value Fcmd_L determined by the right/left desired share determiner 63, and a measured value θ1_L of the knee angle of the left leg link 3L measured by the left knee angle measurement processor 61L.

Similarly, the right instructed current determiner 64R determines an instructed current value Icmd_R of an electric motor 15R on the basis of a measured value Frod_R of the rod transmitting force of the connecting rod 18R measured by the right rod transmitting force measurement processor 62R and the right share desired value Fcmd_R determined by the right/left desired share determiner 63, and a measured value θ1_R of the knee angle of the right leg link 3R measured by the right knee angle measurement processor 61R.

Thus, the control unit 21 has signal lines disposed for the transfer of signals, such as communication, among the rotational actuators 9, the battery management units 19a, and the sensors 11aL, 11aR, 22a, 22b, 23 and 24. The signal lines are thinner than the wiring for supplying electric energy, thus making it unlikely to involve a complicated configuration for the disposing the signal lines.

A communication unit for transferring signals of the communication or the like may alternatively be wireless communication using radio waves or the like rather than cable communication using signal lines. If the wireless communication is used for the communication unit, then there will be no need to dispose signal lines, so that the freedom degree of the structure of the walking assist device A can be improved.

The detailed processing by the control unit 21 will now be described. With the foot-worn units 2R and 2L set on the feet of the user P and the seat member 1 set under the hip of the user P, the power of the control unit 21 is turned on. At this time, the control unit 21 starts counting the elapsed time by the time counter 66, carries out the processing described below at predetermined control cycles, and starts the operation of the walking assist device A.

At each control cycle, the control unit 21 first carries out the processing by the tread force measurement processors 60R and 60L, the processing by the knee angle measurement processors 61R and 61L, and the processing by the rod transmitting force measurement processors 62R and 62L. The processing by the knee angle measurement processors 61 R and 61 L and the processing by the rod transmitting force measurement processors 62R and 62L may alternatively be carried out after or concurrently with the processing by the right/left desired share determiner 63, which will be discussed hereinafter.

The processing by the tread force measurement processors 60R and 60L is carried out as follows. The same algorithm of the processing applies to both the tread force measurement processors 60R and 60L. The processing by the left tread force measurement processor 60L will be representatively described below.

The left tread force measurement processor 60L acquires, as the measured tread force of the left leg tread force Fft_L of the user P, the value obtained by adding up the force detection values indicated by the outputs of the tread force measuring force sensors 22a and 22b of the left leg link 3L (more specifically, the force detection values obtained after filtering of a low-pass characteristic for removing noise components). The same applies to the processing carried out by the right tread force measurement processing 60R.

In the processing by the tread force measurement processors 60R or 60L, the measured tread forces Fft_R or Fft_L may be forcibly set to zero in the case where the sum of the force detection values of the tread force measurement force sensors 22a and 22b corresponding thereto is a very small value that is a predetermined lower limit value or less, or limitation processing may be added to forcibly set the measured tread forces Fft_R or Fft_L to a predetermined upper limit value in the case where the sum exceeds the upper limit value.

As will be discussed hereinafter, according to the present embodiment, basically, the mutual ratios of the leg link share desired values Fcmd_R and Fcmd_L are determined on the basis of the mutual ratios of the measured tread force Fft_R of the right leg and the measured tread force Fft_L of the left leg of the user P. Therefore, adding the aforesaid limitation processing to the processing carried out by the tread force measurement processors 60R and 60L is effective for restraining frequent changes in the mutual ratios of the leg link share desired values Fcmd_R and Fcmd_L.

The processing by the knee angle measurement processors 61R and 61L is carried out as follows. The same algorithm of the processing applies to both the knee angle measurement processors 61R and 61L. The processing by the left knee angle measurement processor 61L will be representatively described below.

Based on the rotational angle of the output shaft 9a of the rotational actuator 9 indicated by an output of the angle sensor 24L, the left knee angle measurement processor 61L determines a tentative measurement value of the knee angle of the leg link 3L according to an arithmetic expression or a data table (an arithmetic expression or a data table indicating the relationship between the rotational angle and the knee angle of the left leg link 3L) set beforehand. Then, the left knee angle measurement processor 61L subjects the tentative measurement value to the filtering of low-pass characteristic so as to remove noise components, thereby obtaining the measured value θ1_L of the knee angle of the leg link 3L. The same applies to the processing by the right knee angle measurement processor 61R.

Supplementarily, the knee angles measured by the knee angle measurement processors 61R and 61L may be the angle θ1 shown in FIG. 2 or a supplementary angle of the angle θ1 (=180°−θ1). Further alternatively, for example, the angle formed by the lengthwise direction of the thigh frame 5 of the leg link 3R or 3L and the straight line connecting the third joint 8 and the second joint 6 of the leg link 3R or 3L, as observed in the direction of the joint axis of the third joint 8 of the leg link 3R or 3L, may be defined as the knee angle. In the following description, the knee angles measured by the knee angle measurement processors 61 R and 61 L are denoted by the angle θ1 shown in FIG. 2.

The processing by the rod transmitting force measurement processors 62R and 62L is carried out as follows. The same algorithm of the processing applies to both the rod transmitting force measurement processors 62R and 62L. The processing by the left rod transmitting force measurement processor 62L will be representatively described below. The left rod transmitting force measurement processor 62L converts the voltage value of a received output of the strain gauge force sensor 23L into a measurement value of the rod transmitting force Frod_L according to an arithmetic expression or a data table (an arithmetic expression or a data table indicating the relationship between the output voltage and the rod transmitting force) set beforehand. The same applies to the processing by the right rod transmitting force measurement processor 62R.

In this case, the output value of each of the strain gauge force sensors 23 or the measurement value of each of the rod transmitting forces Frod_R and Frod_L may be subjected to filtering of low-pass characteristic to remove noise components.

The processing by the leg spread angle measuring unit 65 is carried out as follows. As described above, the leg spread angle θ2 is expressed by the sum of a left leg spread angle θ2L output from the leg spread angle sensor 11aL of the left leg link 3L and a right leg spread angle θ2R output from the leg spread angle sensor 11aR of the right leg link 3R. Hence, the leg spread angle measuring unit 65 obtains the sum of the angles output from the leg spread angle sensors 11aR and 11aL of the right and left leg links 3R and 3L thereby to measure or detect the leg spread angle θ2, and outputs the result to outside, namely, the right/left desired share determiner 23 in this case.

In this case, the output value of each of the leg spread angle measuring unit 65 or the sum of the right leg spread angle θ2R and the left leg spread angle θ2L may be subjected to filtering of low-pass characteristic to remove noise components.

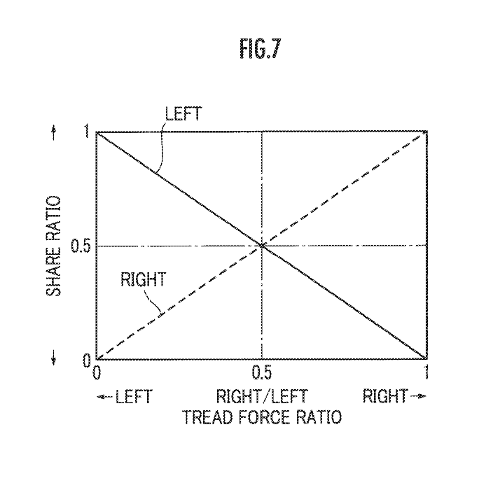

The processing by the right/left desired share determiner 63 carried out under the control of the control unit 21 will now be described. First, the basic method for determining the leg link share desired values Fcmd_R and Fcmd_L will be described. The control unit 21 determines the leg link share desired values Fcmd_R and Fcmd_L on the basis of the right and left measured tread forces Fft_R and Fft_L, respectively, as illustrated in FIG. 7, by the processing carried out by the right/left desired share determiner 63. In FIG. 7, the axis of abscissas indicates the ratio between the right and left measured tread forces Fft_R and Fft_L (hereinafter referred to as “the right/left tread force ratio”), while the axis of ordinates indicates right and left share ratios Ratio_R and Ratio_L of the leg link share desired values Fcmd_R and Fcmd_L.

Herein, the share ratio of the left leg link 3L (hereinafter referred to as “the left share ratio”) Ratio_L denotes the ratio of the left share desired value Fcmd_L relative to the assist device borne support force, while the share ratio of the right leg link 3R (hereinafter referred to as “the right share ratio”) Ratio_R denotes the ratio of the right share desired value Fcmd_R relative to the assist device borne support force.

The solid line in FIG. 7 indicates the relationship between the right/left tread force ratio and the left share desired value Fcmd_L of the left leg link 3L, while the dashed line in FIG. 7 indicates the relationship between the right/left tread force ratio and the right share desired value Fcmd_R of the right leg link 3R. Hereinafter, the map showing the relationship between the right/left tread force ratio and the share ratios Ratio_R and Ratio_L, as shown in FIG. 7, will be referred to as the distribution ratio map.

In the present embodiment, the right/left tread force ratio is denoted by “Fft_R/(Fft_L+Fft_R)”. More specifically, the right/left tread force ratio is 0.5 when the measured tread force of the right leg Fft_R and the measured tread force of the left leg Fft_L are equal, and located at the midpoint on the axis of abscissas in FIG. 7. Further, the right/left tread force ratio takes a value that is smaller than 0.5 when the measured tread force of the left leg Fft_L is larger than the measured tread force of the right leg Fft_R, and the value is on the left side from the midpoint on the axis of abscissas in FIG. 7. Meanwhile, the right/left tread force ratio takes a value that is larger than 0.5 when the measured tread force of the left leg Fft_L is smaller than the measured tread force of the right leg Fft_R, and the value is on the right side from the midpoint on the axis of abscissas in FIG. 7. If the measured tread force of the right leg Fft_R is zero and the measured tread force of the left leg Fft_L takes a value that is larger than zero, then the right/left tread force ratio is zero and at the left end of the axis of abscissas. Meanwhile, if the measured tread force of the left leg Fft_L is zero and the measured tread force of the right leg Fft_R takes a value that is larger than zero, then the right/left tread force ratio is one and at the right end of the axis of abscissas.

The right/left tread force ratio may alternatively be expressed by other techniques, including “Fft_L/(Fft_L+Fft_R)” rather than being limited to “Fft_R/(Fft_L+Fft_R).”

Further, the sum of the right share desired value Fcmd_R and the left share desired value Fcmd_L provides the assist device borne support force. Hence, the sum of the right share ratio Ratio_R and the left share ratio Ratio_L is set so that it becomes one. In other words, the solid line and the dashed line in FIG. 7 are set such that the total of the right share ratio Ratio_R and the left share ratio Ratio_L corresponding to a predetermined right/left tread force ratio is always one.

Then, the left share ratio Ratio_L (the solid line in FIG. 7) and the right share ratio Ratio_R (the dashed line in FIG. 7) are determined on the basis of the right/left tread force ratio obtained from the measured tread forces Fft_R and Fft_L.

If the right/left tread force ratio is 0.5 (Fft_R=Fft_L) then it means that the tread forces of the right and left legs of the user P are equal, and the force acting on the user P from the walking assist device A is desirably in the vertical and upward direction, i.e., in the direction opposite from the direction in which the gravity acts. For this reason, the right share ratio Ratio_R and the left share ratio Ratio_L are set to the same value such that the lifting forces acting on the user P from the seat member 1 by the drive torques imparted to the third joints 8 of the leg links 3R and 3L will be equal, which is indicated by the midpoint of the axis of ordinates in FIG. 7.

Further, as illustrated in FIG. 7, if the right/left tread force ratio is smaller than 0.5 (Fft_L>Fft_R), then it means that the tread force of the left leg of the user P is larger than that of the right leg of the user P, and the force acting on the user P from the walking assist device A is desirably oriented in an obliquely upward direction from the left leg side to the right leg side. For this reason, the left share ratio Ratio_L is set to a value that is larger than the value of the right share ratio Ratio_R such that the lifting force acting on the user P from the seat member 1 due to the drive torque imparted to the third joint 8 is larger on the right leg link 3R than on the left leg link 3L.

Further, if the right/left tread force ratio is larger than 0.5 (Fft_L <Fft_R), then it means that the tread force of the right leg of the user P is larger than that of the left leg of the user P, and the force acting on the user P from the walking assist device A is desirably oriented in an obliquely upward direction from the right leg side to the left leg side. For this reason, the right share ratio Ratio_R is set to a value that is larger than the value of the left share ratio Ratio_L such that the lifting force acting on the user P from the seat member 1 due to the drive torque imparted to the third joint 8 is larger on the left leg link 3L than on the right leg link 3R.

As illustrated in FIG. 7, the left share ratio Ratio_L is denoted by a straight line on which the left share ratio Ratio_L is 1 when the right/left tread force ratio is 0 (at the left end of the axis of abscissas in FIG. 7), 0.5 when the right/left tread force ratio is 0.5 (at the midpoint of the axis of abscissas in FIG. 7), and 0 when the right/left tread force ratio is 1 (at the right end of the axis of abscissas in FIG. 7). The right share ratio Ratio_R is laterally symmetrical to the left share ratio Ratio_L, and denoted by a straight line on which the right share ratio Ratio_R is 0 when the right/left tread force ratio is 0 (at the left end of the axis of abscissas in FIG. 7), 0.5 when the right/left tread force ratio is 0.5 (at the midpoint of the axis of abscissas in FIG. 7), and 1 when the right/left tread force ratio is 1 (at the right end of the axis of abscissas in FIG. 7).

According to the present embodiment, the slopes and intercepts of the equations of the straight lines are determined from the positions of two points that the straight lines pass, then the right share ratio Ratio_R and the left share ratio Ratio_L are determined on the basis of the right/left tread force ratio.

The walking assist device A cannot properly assist walking unless every actuator outputs a proper force according to the tread force of each of the right and left legs of the user P. Therefore, if any one of the actuators becomes incapable of outputting a force, then the assist of walking should be suspended. Hence, if the leg link share desired values Fcmd_R and Fcmd_L are determined on the basis of only a right/left tread force ratio, i.e., if they are determined without considering the SOC of the battery 19 of each of the leg links 3R and 3L, then even if the SOC of one battery 19 is sufficiently high to drive the walking assist device A, the operation of the walking assist device A will be stopped with resultant reduced time of availability if the SOC of the other battery 19 reaches zero or a value close to zero.

To avoid the problem described above, according to the present embodiment, when determining the leg link share desired values Fcmd_R and Fcmd_L, the SOC of the battery 19 of each of the leg links 3R and 3L is taken into account in addition to the right/left tread force ratio, thereby carrying out control such that the difference in the SOC between the batteries 19 is maintained at zero or a value close to zero. Further details will be described below.

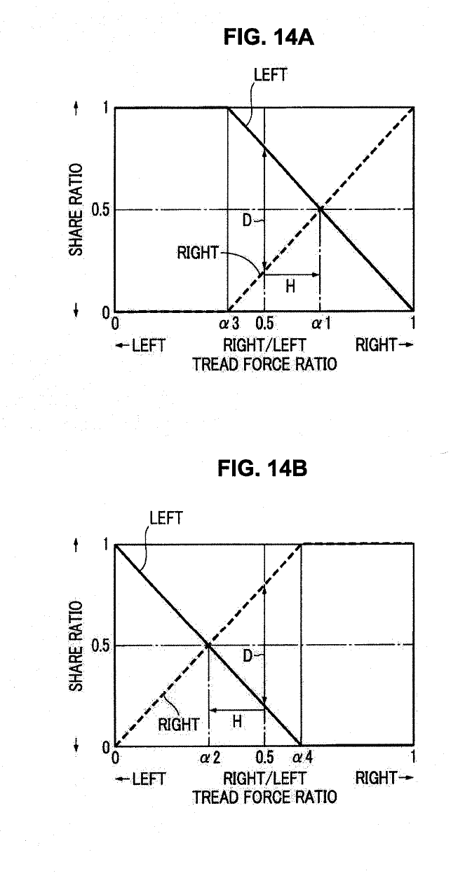

FIG. 8 illustrates a relationship between the right/left tread force ratio and the leg link share desired values Fcmd_R and Fcmd_L in a case where there is a difference in SOC between the two batteries 19. More specifically, FIG. 8(a) illustrates a case where a left detected remaining amount of charge SOC_L is larger than a right detected remaining amount of charge SOC_R. FIG. 8(b) illustrates a case where the left detected remaining amount of charge SOC_L is smaller than the right detected remaining amount of charge SOC_R. In FIG. 8, and FIGS. 13A, 13B, 14A, and 14B, which will be discussed hereinafter, the axis or ordinates, the axis of abscissas, the solid line, and the dashed line denote the same as those in FIG. 7.

In the case where the left detected remaining amount of charge SOC_L is larger than that of a right detected remaining amount of charge SOC_R, the left share desired value Fcmd_L is set to be larger than the right share desired value Fcmd_R even if the right/left tread force ratio is 0.5 (Fft_R=Fft_L), as illustrated in FIG. 8A. This causes the battery 19 of the left leg link 3L to consume more electric energy than the battery 19 of the right leg link 3R does, thus making it possible to reduce the difference between the right detected remaining amount of charge SOC_R and the left detected remaining amount of charge SOC_L.

Further, if the right/left tread force ratio is smaller than 0.5 (Fft_L>Fft_R), then the left share desired value Fcmd_L is set to be larger than the right share desired value Fcmd_R and the difference therebetween (Fcmd_L−Fcmd_R) is set to be larger than that in a case where the two SOCs do not have variations (refer to the distribution ratio map in FIG. 7).

Further, if the right/left tread force ratio is larger than 0.5 (Fft_L<Fft_R), then the left share desired value Fcmd_L is set to be larger than the right share desired value Fcmd_R when the right/left tread force ratio is below a predetermined right/left tread force ratio α1 (where α1>0.5). If the right/left tread force ratio is larger than 0.5 (Fft_L<Fft_R) and the right/left tread force ratio is the predetermined right/left tread force ratio α1, then the left share desired value Fcmd_L is set to the same value as that of the right share desired value Fcmd_R. If the right/left tread force ratio is larger than 0.5 (Fft_L<Fft_R) and the right/left tread force ratio is larger than the predetermined right/left tread force ratio α1, then the left share desired value Fcmd_L is set to be smaller than the right share desired value Fcmd_R.

Thus, if the left detected remaining amount of charge SOC_L is larger than the right detected remaining amount of charge SOC_R, then the left share ratio Ratio_L is denoted by a straight line that reaches 1 when the right/left tread force ratio is 0 in a zone in which the right/left tread force ratio ranges from 0 to α1 and that reaches 0.5 when the right/left tread force ratio is the predetermined right/left tread force ratio α1, as illustrated in FIG. 8A. The left share ratio Ratio_L is further denoted by a straight line that reaches 0.5 when the right/left tread force ratio is α1 in a zone in which the right/left tread force ratio ranges from α1 to 1 and that reaches 0 when the right/left tread force ratio is 1. Further, the right share ratio Ratio_R is denoted by a straight line that reaches 0 when the right/left tread force ratio is 0 in a zone in which the right/left tread force ratio ranges from 0 to α1 and that reaches 0.5 when the right/left tread force ratio is the predetermined right/left tread force ratio α1. The right share ratio Ratio_R is further denoted by a straight line that reaches 0.5 when the right/left tread force ratio is α1 in a zone in which the right/left tread force ratio ranges from α1 to 1 and that reaches 1 when the right/left tread force ratio is 1.

If the left detected remaining amount of charge SOC_L is smaller than the right detected remaining amount of charge SOC_R, then the distribution ratio map therefor will be obtained by laterally reversing the distribution ratio map that applies to the case where the left detected remaining amount of charge SOC_L is larger than the right detected remaining amount of charge SOC_R. More specifically, in this case, as illustrated in FIG. 8B, the left share ratio Ratio_L is denoted by a straight line that reaches 1 when the right/left tread force ratio is 0 in a zone in which the right/left tread force ratio ranges from 0 to α2 (where α2<0.5) and that reaches 0.5 when the right/left tread force ratio is the predetermined right/left tread force ratio α2 and further denoted by another straight line that reaches 0.5 when the right/left tread force ratio is α2 in a zone in which the right/left tread force ratio ranges from α2 to 1 and that reaches 0 when the right/left tread force ratio is 1. Further, the right share ratio Ratio_R is denoted by a straight line that reaches 0 when the right/left tread force ratio is 0 in a zone in which the right/left tread force ratio ranges from 0 to α2 and that reaches 0.5 when the right/left tread force ratio is the predetermined right/left tread force ratio α2 and further denoted by another straight line that reaches 0.5 when the right/left tread force ratio is α2 in a zone in which the right/left tread force ratio ranges from α2 to 1 and that reaches 1 when the right/left tread force ratio is 1.

As with the distribution ratio map shown in FIG. 7, it is set such that the total of the left share desired value Fcmd_L and the right share desired value Fcmd_R corresponding to a predetermined right/left tread force ratio is always I also in the distribution ratio maps shown in FIGS. 8A and 8B.

Thus, according to the present embodiment, if there is a difference in the SOC between the battery 19 of the right leg link 3R and the battery 19 of the left leg link 3L, then the control unit 21 decreases the drive force of the rotational actuator 9 of the leg link (3R or 3L) that has the battery 19 of a lower SOC and increases the drive force of the rotational actuator 9 of the leg link (3L or 3R) that has the battery 19 of a higher SOC, as compared with the drive forces of the rotational actuators 9 of the leg links 3R and 3L in the case where the SOCs are equal. This causes more electric energy of the battery 19 of the leg link (3L or 3R) that has a higher SOC to be easily consumed, thus making it easy to reduce a difference in the SOC between the batteries 19 (hereinafter referred to as “the difference in the remaining amount of charge”) SOC_d.

As described above, although the walking assist device A has a plurality of (two) batteries 19, the difference in the SOC between the batteries 19 is easily reduced by using the distribution ratio maps shown in FIGS. 8A and 8B, thus making it possible to restrain the operating time of the walking assist device A from decreasing.

The distribution ratio maps shown in FIGS. 8A and 8B are determined on the basis of the difference in the remaining amount of charge SOC_d. According to the preset embodiment, a distribution ratio map is determined by determining a manipulated variable H. The manipulated variable H means the amount of displacement of the position of the right/left tread force ratio at which each of the share ratios Ratio_R and Ratio_L becomes 0.5 in a lateral direction from the position at which the right/left tread force ratio is 0.5. More specifically, if the SOCs of the batteries 19 are the same, as the case illustrated in FIG. 7, then the right/left tread force ratio at which the share ratios Ratio_R and Ratio_L become 0.5 is 0.5 (the center of the axis of ordinates in FIG. 7), and the manipulated variable H will be zero. If the SOC of the battery 19 of the left leg link 3L is higher than that of the right leg link 3R (SOC_L>SOC_R), as in the case illustrated in FIG. 8A, then the right/left tread force ratio at which the share ratios Ratio_R and Ratio_L become 0.5 is α1, and the manipulated variable H will be “α1−0.5.” Further, if the SOC of the battery 19 of the right leg link 3R is higher than that of the left leg link 3L (SOC_L<SOC_R), as in the case illustrated in FIG. 8B, then the right/left tread force ratio at which the share ratios Ratio_R and Ratio_L become 0.5 is α2, and the manipulated variable H will be “0.5−α2.”

As the manipulated variable H is determined, the distribution ratio map is determined. If the SOC of the battery 19 of the left leg link 3L is higher than that of the right leg link 3R (SOC_L>SOC_R), then the calculation is to be performed by defining the predetermined right/left tread force ratio α1 as “H+0.5.” Subsequently, as described above, the left share ratio Ratio_L is denoted by a straight line that reaches 1 when the right/left tread force ratio is 0 in a zone in which the right/left tread force ratio ranges from 0 to α1 and that reaches 0.5 when the right/left tread force ratio is the predetermined right/left tread force ratio α1, and a straight line that reaches 0.5 when the right/left tread force ratio is α1 in a zone in which the right/left tread force ratio ranges from α1 to 1 and that reaches 0 when the right/left tread force ratio is 1. The right share ratio Ratio_R is denoted by a straight line that reaches 0 when the right/left tread force ratio is 0 in a zone in which the right/left tread force ratio ranges from 0 to α1 and that reaches 0.5 when the right/left tread force ratio is the predetermined right/left tread force ratio α1, and by a straight line that reaches 0.5 when the right/left tread force ratio is α1 in a zone in which the right/left tread force ratio ranges from α1 to 1 and that reaches 1 when the right/left tread force ratio is 1.

If the SOC of the battery 19 of the right leg link 3R is higher than that of the left leg link 3L (SOC_L<SOC_R), then the calculation is to be performed by defining the predetermined right/left tread force ratio α2 as “0.5−H.” As described above, the left share ratio Ratio_L is denoted by a straight line that reaches 1 when the right/left tread force ratio is 0 in a zone in which the right/left tread force ratio ranges from 0 to α2 and that reaches 0.5 when the right/left tread force ratio is the predetermined right/left tread force ratio α2, and by a straight line that reaches 0.5 when the right/left tread force ratio is α2 in a zone in which the right/left tread force ratio ranges from α2 to 1 and that reaches 0 when the right/left tread force ratio is 1. The right share ratio Ratio_R is denoted by a straight line that reaches 0 when the right/left tread force ratio is 0 in a zone in which the right/left tread force ratio ranges from 0 to α2 and that reaches 0.5 when the right/left tread force ratio is the predetermined right/left tread force ratio α2, and by a straight line that reaches 0.5 when the right/left tread force ratio is α2 in a zone in which the right/left tread force ratio ranges from α2 to 1 and that reaches 1 when the right/left tread force ratio is 1.

In the present embodiment, the slopes and intercepts of the equations of the straight lines are determined from the positions of two points that the straight lines pass, then the right share ratio Ratio_R and the left share ratio Ratio_L are determined on the basis of the right/left tread force ratios.

If the SOCs of the batteries 19 are the same (SOC_R_R=SOC_L), then the manipulated variable H will be zero, and the distribution ratio map will be the one as shown in FIG. 7.

The control unit 21 controls the SOC of each of the batteries 19 by determining the manipulated variable H on the basis of the difference in the remaining amount of charge SOC_d, as described above. In other words, the control unit 21 uses the difference in the remaining amount of charge SOC_d of the preceding control cycle as a feedback component to determine the manipulated variable H for a current control cycle, thereby controlling the SOC of each of the batteries 19.

According to the present embodiment, the control unit 21 carries out control such that the value of the manipulated variable H increases as the difference in the remaining amount of charge SOC_d increases (hereinafter referred to as “the proportional control”).

As the value of the manipulated variable H increases, the share ratio (Ratio_R or Ratio_L) of the leg link (3R or 3L) that has a higher SOC increases, while the share ratio (Ratio_L or Ratio_R) of the leg link (3L or 3R) that has a lower SOC decreases, as compared with the case where the value of the manipulated variable H is smaller. With this arrangement, the difference in the remaining amount of charge SOC_d can be reduced more promptly.

The proportional control by the control unit 21 corresponds to “the controller controls two drive sources such that the difference in the electric energy supplied to the drive sources corresponding to predetermined two batteries increases as the difference in the remaining amount of charge of the predetermined two batteries among a plurality of batteries increases” in the present invention.

Further, according to the present embodiment, the control unit 21 carries out control such that the value of the manipulated variable H increases as the state, in which there is a difference in the SOC between the batteries 19, lasts for longer time (hereinafter referred to as “the integral control”). The control unit 21 stores and retains the differences in the remaining amount of charge SOC_d in a memory, which is not shown. The control unit 21 detects the time of the continuance of the state, in which the difference exists in the SOC, from the plurality of the stored and retained differences in the remaining amount of charge SOC_d. Thus, the difference in the remaining amount of charge SOC_d can be reduced more promptly by increasing the manipulated variable H.

The integral control by the control unit 21 corresponds to “the controller controls two drive sources such that the difference in the electric energy supplied to the drive sources corresponding to predetermined two batteries increases as the state, in which there is a difference in the remaining amount of charge of the predetermined two batteries among a plurality of batteries, lasts longer” in the present invention.

Further, in the present embodiment, the control unit 21 carries out control such that the value of the manipulated variable H increases as a time-dependent change amount of the difference in the SOC between the batteries 19 increases (hereinafter referred to as “the derivative control”). The control unit 21 calculates the difference between the differences in the remaining amounts of charge SOC_d for every adjacent control cycles among the plurality of the stored and retained differences in the remaining amount of charge SOC_d, thereby detecting the time-dependent change amount of the difference in the remaining amount of charge SOC_d. Thus, the difference in the remaining amount of charge SOC_d can be reduced more promptly by increasing the manipulated variable H.

The derivative control by the control unit 21 corresponds to “the controller controls two drive sources such that the difference in the electric energy supplied to the drive sources corresponding to predetermined two batteries among a plurality of batteries increases as the time-dependent change amount of the difference in the remaining amount of charge of the predetermined two batteries increases” in the present invention.

The control unit 21 carries out the so-called PID control as the feedback control for determining the manipulated variable H by the proportional control, the integral control and the derivative control described above. More specifically, the control unit 21 determines the manipulated variable H by adding a term obtained by multiplying the difference in the remaining amount of charge SOC_d by a predetermined gain Kp (proportional), an integral value obtained by multiplying the difference in the remaining amount of charge SOC_d by a predetermined gain Ki (integral term), and a derivative value obtained by multiplying the difference in the remaining amount of charge SOC_d by a predetermined gain Kd (differential). Thus, the SOC of each of the batteries 19 is controlled (by the PID control) such that the SOC of each of the batteries 19 becomes equal more promptly and more stably. The predetermined gains Kp, Ki and Kd are determined by experiments or the like and stored and retained beforehand in a memory, which is not shown.

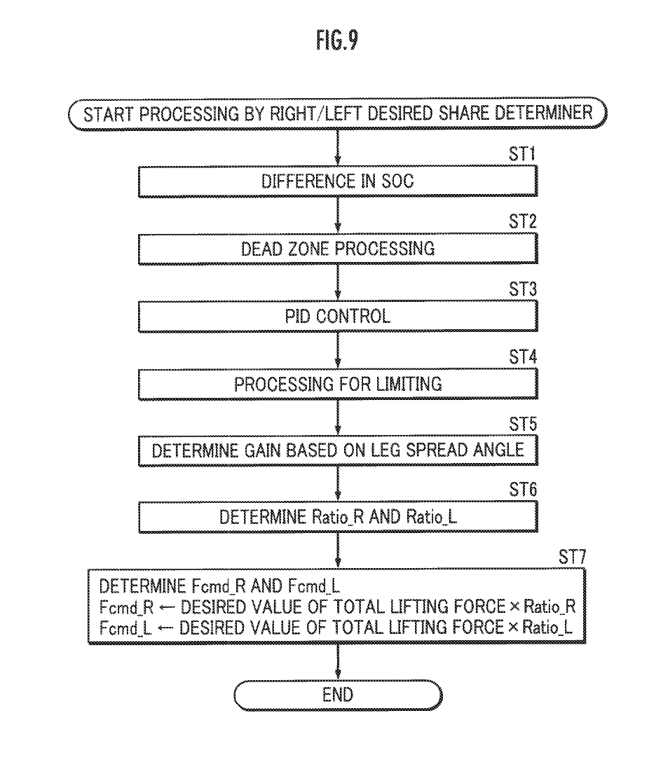

Subsequently, the control unit 21 carries out the processing by the right/left desired share determiner 63. Referring to FIG. 9, the processing will be described in detail below. FIG. 9 illustrates the flow of the processing by the right/left desired share determiner 63 carried out under the control of the control unit 21.

In a first step ST1, the difference between a left detected remaining amount of charge SOC_L and a right detected remaining amount of charge SOC_R, i.e., the difference in the remaining amount of charge SOC_d, is calculated. The difference in the remaining amount of charge SOC_d is calculated as “SOC_d=SOC_L−SOC_R.” Alternatively, the difference in the remaining amount of charge SOC_d may be calculated as “SOC_d =SOC_R−SOC_L.”

Next, the control unit 21 proceeds to step ST2 to carry out dead zone processing. In the dead zone processing, if the absolute value of the difference in the remaining amount of charge SOC_d calculated in step ST1 is a predetermined value or less, then it is assumed that the difference is zero, i.e., there is no difference. Hence, if the difference in the remaining amount of charge SOC_d has a small value, then it is assumed that there is no difference in the remaining amount of charge SOC_d.

Depending on the operating situation of the walking assist device A, a difference in the SOC frequently occurs between the batteries 19. In response to such frequent occurrence, changing the drive force of a rotational actuator 9 to immediately catch up with the occurrence tends to cause the user P to feel uncomfortable. For this reason, the drive force of the rotational actuator 9 is changed, i.e., the distribution ratio map is changed, only when the difference in the remaining amount of charge SOC_d is a predetermined value or more, thus permitting improved convenience to the user P. The predetermined value is determined by experiments or the like, taking the performance or the like of the batteries 19 into account so as to obtain a value that will not impair the user-friendliness of the walking assist device A, and the value is stored and retained beforehand in a memory, which is not shown.

The processing in step ST2 described above corresponds to “the controller controls a plurality of drivers on the basis of a detection result of the remaining amount detector if the difference in the remaining amount of charge of predetermined two batteries among a plurality of batteries is a predetermined value or more” in the present invention.

Subsequently, the control unit 21 proceeds to step ST3 to carry out the PID control based on the proportional control, the integral control, and the derivative control described above. Thus, the manipulated variable H is determined from the difference in the remaining amount of charge SOC_d determined in steps ST1 and ST2 is determined.

The processing in step ST3 described above corresponds to the processing in which “the controller controls two drive sources such that the difference in the electric energy supplied to the drive sources corresponding to predetermined two batteries increases as the difference in the remaining amount of charge of the predetermined two batteries among a plurality of batteries increases,” the processing in which “the controller controls two drive sources such that the difference in the electric energy supplied to the drive sources corresponding to predetermined two batteries increases as the state, in which there is a difference in the remaining amount of charge of the predetermined two batteries among a plurality of batteries, lasts longer,” and the processing in which “the controller controls two drive sources such that the difference in the electric energy supplied to the drive sources corresponding to predetermined two batteries among a plurality of batteries increases as the time-dependent change amount of the difference in the remaining amount of charge of the predetermined two batteries increases” in the present invention.

Subsequently, the control unit 21 proceeds to step ST4, in which, if the manipulated variable H determined in step ST3 exceeds a predetermined upper limit value, then the control unit 21 sets the predetermined upper limit value as an updated manipulated variable H again. The predetermined upper limit value is determined by experiments or the like such that it is a value that will prevent the manipulated variable H obtained by the calculation based on the PID control from becoming excessively large, causing the user P to feel uncomfortable. The determined upper limit value is stored and retained beforehand in a memory, which is not shown.

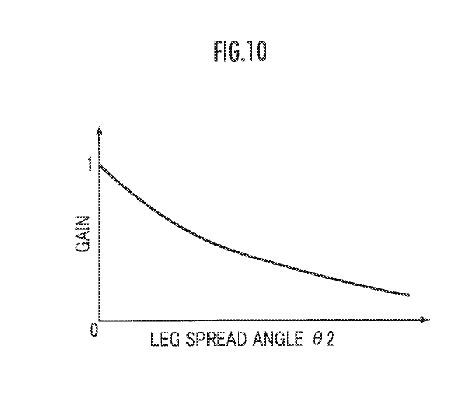

Subsequently, the control unit 21 proceeds to step ST5 to set the manipulated variable H again by using a gain based on the leg spread angle θ2 shown in FIG. 10. In FIG. 10, the axis of abscissas indicates the leg spread angle θ2, while the axis of ordinates indicates the gain. The gain is set to 1 when the leg spread angle θ2 is 0, and also set to decrease as the leg spread angle θ2 increases.

As described above, the walking assist device A determines the leg link share desired values Fcmd_R and Fcmd_L based on the right/left tread force ratio of the user P, as illustrated in FIG. 7, in the case where the SOCs of the batteries 19 are equal.

However, if there is a difference in the SOC of the batteries 19, the leg link share desired values Fcmd_R and Fcmd_L are determined by considering the detected remaining amounts of charge SOC_R and SOC_L in addition to the right/left tread force ratio of the user P. Therefore, for example, even if the right/left tread force ratio is 0.5, the direction of a force acting on the user P from the walking assist device A will not be vertical and upward (the direction opposite from the acting direction of gravity). Instead, the direction will be obliquely upward from the leg link side having a higher SOC to the leg link having a lower SOC.

At this time, if the difference between the right share desired value Fcmd_R and the left share desired value Fcmd_L is large, then the direction in which a force acting on the user P from the walking assist device A forms a large angle in relation to the vertical and upward direction (the opposite direction from the acting direction of gravity), as compared with the case where the difference is small. In other words, in this case, the direction of the force applied by the walking assist device A is significantly different from the direction in the case where the SOCs are the same. At this time, as the leg spread angle θ2 increases, the difference in the direction of the force increases, frequently making the user P feel uncomfortable. If there is a difference in the SOC between the batteries 19 even when the right/left tread force ratio is not 0.5, the direction of the force applied from the walking assist device A to the user P will be also different, as compared with the case where the SOCs are the same, frequently causing the user P to feel uncomfortable.

Thus, the unpleasant sensation of the user P is reduced by setting the manipulated variable H such that, as the leg spread angle θ2 increases, the predetermined right/left tread force ratios α1 and α2 decrease from the ones before the leg spread angle θ2 increases. The map indicating the relationship between the leg spread angle θ2 and the gain shown in FIG. 10 has a curve projecting downward in the present embodiment; however, the map is not limited thereto. For example, the map may use a straight line, the inclination of which has negative numbers, or may be other types, as long as it indicates monotonous decrease.

The processing in step ST5 described above corresponds to the processing in which “the controller controls two drive sources such that the difference in the electric energy supplied to predetermined two drive sources among a plurality of drive sources decreases as an angle formed by the leg link resultant forces of the predetermined two drive sources increases” in the present invention.

Subsequently, the control unit 21 proceeds to step ST6 to determine a distribution ratio map on the basis of the final manipulated variable H determined in step ST5. If the manipulated variable H is zero, then the distribution ratio map indicating that the SOCs of the batteries 19 are equal, as illustrated in FIG. 7, results. If the manipulated variable H is not zero, then the distribution ratio map indicating that the SOC differs between the batteries 19 as illustrated in FIG. 8, results. Based on the manipulated variable H, the distribution ratio map is determined and the share ratios Ratio_R and Ratio_L are determined on the basis of the right/left tread force ratio.

Subsequently, the control unit 21 proceeds to step ST7 to determine the leg link share desired values Fcmd_R and Fcmd_L. At this time, the leg link share desired value for the right leg link 3R is calculated by “the desired value of a total lifting force x Ratio_R,” while the leg link share desired value for the left leg link 3L is calculated by “the desired value of a total lifting force x Ratio_L.”

The desired value of a total lifting force in the present embodiment is set beforehand as described below and stored and retained in a memory, which is not shown. For example, the magnitude of the gravitational force acting on the weight obtained by adding the total weight of the walking assist device A (or the weight obtained by subtracting the total weight of the two foot-worn units 2R and 2L from the total weight of the walking assist device A) and the weight of a part of the weight of the user P to be supported by a lifting force applied to the user P from the seat member 1,e.g., the weight obtained by multiplying the full weight of the user P by a preset ratio (the weight obtained by the aforesaid addition x gravitational acceleration) is set as the desired value of the total lifting force. In this case, an upward translational force having a magnitude equivalent to the gravitational force acting on a part of the weight of the user P is eventually set as the desired lifting force to be applied from the seat member 1 to the user P.

Alternatively, an arrangement may be made such that the magnitude of a desired lifting force to be applied to the user P from the seat member 1 can be directly set, and the sum of the magnitudes of the desired lifting force and the gravitational force acting on the total weight of the walking assist device A (or the weight obtained by subtracting the total weight of the two foot-worn units 2R and 2L from the total weight of the walking assist device A) may be set as the desired value of the total lifting force. If a vertical inertial force generated by a motion of the walking assist device A becomes relatively large in relation to the aforesaid gravitational force, then the magnitude of the total force of the inertial force and the gravitational force may be set as the desired value of the total lifting force. In this case, it is necessary to sequentially estimate the inertial force, and the estimation can be accomplished by using a technique disposed in, for example, Japanese Patent Application Laid-Open No. 2007-330299.

The above has described the processing by the right/left desired share determiner 63 of the control unit 21.

The control unit 21 determines the manipulated variable H on the basis of the difference in the remaining amount of charge SOC_d by the processing in steps ST1 to ST7, and determines the leg link share desired values Fcmd_R and Fcmd_L from the share ratios Ratio_R and Ratio_L determined according to the distribution ratio map obtained from the manipulated variable H, thereby controlling the rotational actuators 9. This corresponds to “in the case where there is a difference in the remaining amount of charge among the batteries, the controller controls a plurality of drivers such that a drive source corresponding to a battery having a smaller remaining amount of charge generates a smaller output, while a drive source corresponding to a battery having a larger remaining amount of charge generates a larger output, as compared with the outputs of the drive sources in the case where the remaining amounts of charge of the batteries are the same” in the present invention.

Further, the processing in steps ST1 to ST7 in the case of the motion assist device that assists the motion of the user P corresponds to “in the case where there is a difference in the remaining amount of energy among energy sources, the controller controls a plurality of drivers such that a drive source corresponding to an energy source having a smaller remaining amount of energy generates a smaller output, while a drive source corresponding to an energy source having a larger remaining amount of energy generates a larger output, as compared with the outputs of the drive sources in the case where the energy sources have the same remaining amounts of energy” in the present invention.

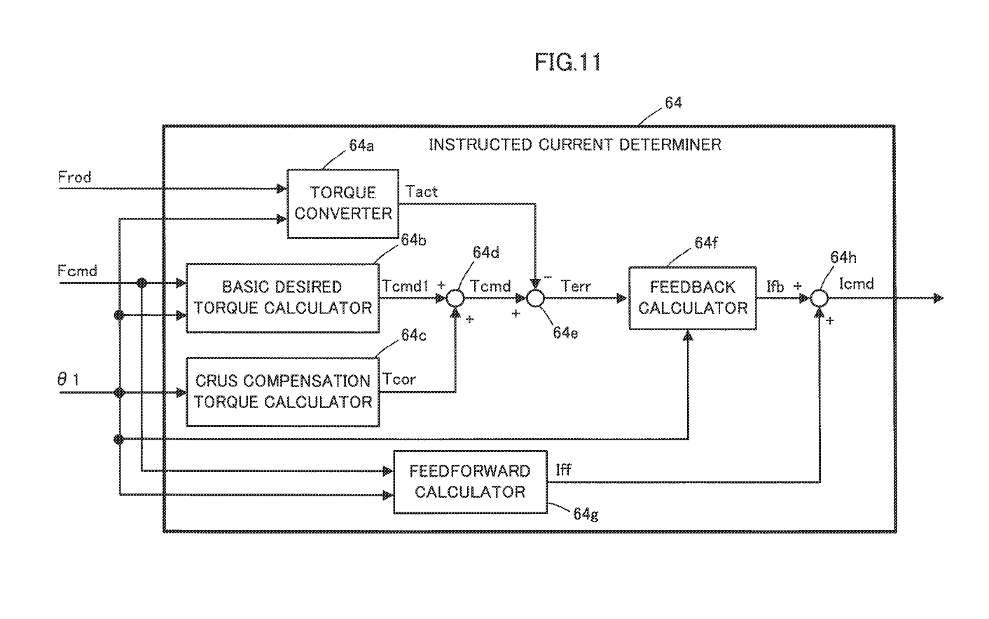

After carrying out the processing by the right/left desired share determiner 63 as described above, the control unit 21 carries out the processing by the instructed current determiners 64R or 64L. The same processing algorithm applies to both the instructed current determiners 64R and 64L, so that the processing by the left instructed current determiner 64L will be representatively described below with reference to FIG. 11. FIG. 11 is a block diagram illustrating the functional sections of the left instructed current determiner 64L. In the description of the processing by the left instructed current determiner 64L, the addition of the reference characters “R” or “L” at the end of each reference numeral may be omitted, but every reference numeral will be related to the left leg link 3L (the one with the character “L” omitted) unless otherwise specified.

The left instructed current determiner 64L includes a torque converter 64a, which converts a measured value Frod of the rod transmitting force of the connecting rod 18 by the left rod transmitting force measurement processor 62L into a value of drive torque Tact actually imparted to the third joint 8 on the basis of the measured value Frod (hereinafter referred to as the actual joint torque Tact), a basic desired torque calculator 64b, which determines a basic desired torque Tcmd1, which is the basic value of a desired value of a drive torque to be imparted to the third joint 8 on the basis of the left share desired value Fcmd determined by the right/left desired share determiner 63, and a crus compensation torque calculator 64c, which determines torque Tcor to be additionally imparted to the third joint 8 to compensate for an influence of a frictional force or the like generated due to a rotational motion of the crus frame 7 with respect to the thigh frame 5 when the third joint 8 is driven (hereinafter referred to as the crus compensation torque Tcor).

The left instructed current determiner 64L further includes an addition calculator 64d, which adds the crus compensation torque Tcor determined by the crus compensation torque calculator 64c to the basic desired torque Tcmd1 determined by the basic desired torque calculator 64b thereby to determine a desired joint torque Tcmd as the final (at a current control cycle) desired value of the drive torque to be imparted to the third joint 8 from the rotational actuator 9 through the intermediary of the motive power transmitting mechanism 10, a subtraction calculator 64e, which determines a difference Terr (=Tcmd−Tact) between the desired joint torque Tcmd and an actual joint torque Tact determined by the torque converter 64a, a feedback calculator 64f, which determines a feedback manipulated variable Ifb of an instructed current value of the electric motor 15 required to set an error Terr to zero (to match Tact to Tcmd), a feedforward calculator 64g, which determines a feedforward manipulated variable Iff of the instructed current value of the electric motor 15 required to cause an actual total lifting force share of the left leg link 3L to reach a leg link share desired value, and an addition calculator 64h, which determines a final instructed current value Icmd by adding the feedback manipulated variable Ifb and the feedforward manipulated variable Iff.

The left instructed current determiner 64L first carries out the processing by the torque converter 64a, the basic desired torque calculator 64b, and the crus compensation torque calculator 64c as described below.

The torque converter 64a receives the measured value Frod of the rod transmitting force of the connecting rod 18 of the motive transmitting mechanism 10 of the left leg link 3L and the measured value θ1 of the knee angle of the left leg link 3L.

In this case, if the distance between the joint axis of the third joint 8 and the pivotal portion 18b of the connecting rod 18 in a direction orthogonal to the lengthwise direction of the connecting rod 18 (=the direction of the rod transmitting force) is denoted by r, then the value obtained by multiplying the measured value Frod of the rod transmitting force by the distance r (hereinafter referred to as the effective radius length r) is the aforesaid actual joint torque Tact. The effective radius length r is determined according to the knee angle of the left leg link 3L.

Then, the torque converter 64a determines the effective radius length r from the received measured value θ1 of the knee angle according to an arithmetic expression or a data table (an arithmetic expression or a data table indicating the relationship between the knee angle and the effective radius length), which has been set in advance. Subsequently, the torque converter 64a multiplies the determined effective radius length r by the received measured value Frod of the rod transmitting force so as to determine the actual joint torque Tact to be imparted to the third joint 8 by the rod transmitting force of the measured value Frod.

The processing by the torque converter 64a is, in other words, arithmetic processing for calculating a vector product (outer product) of the vector of the rod transmitting force and the positional vector of the pivotal portion 18b of the connecting rod 18 relative to the joint axis of the third joint 8.

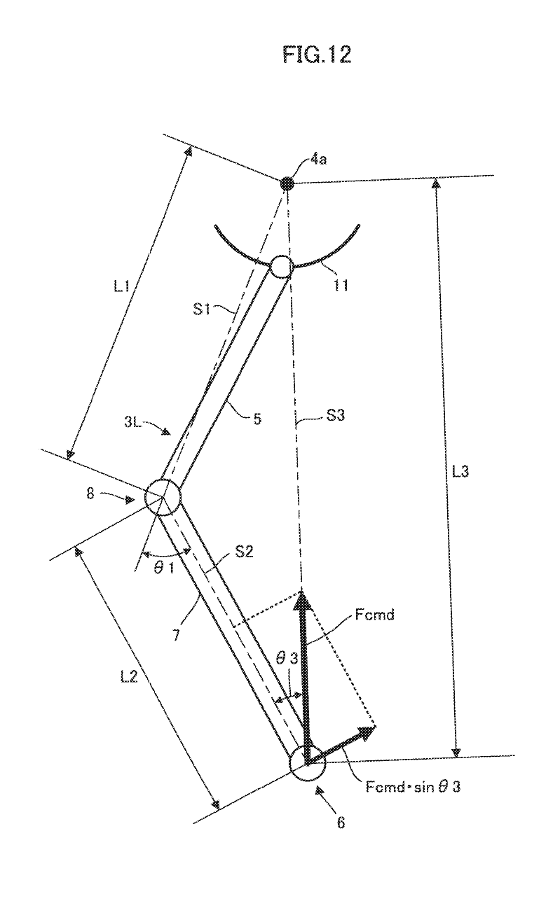

The basic desired torque calculator 64b receives a left share desired value Fcmd determined by the right/left desired share determiner 63 and the measured value θ1 of the knee angle of the left leg link 3L. Subsequently, the basic desired torque calculator 64b determines the basic desired torque Tcmd1 from the received values as follows. The processing will be described below by referring to FIG. 12. FIG. 12 schematically illustrates the configuration of an essential section of the left leg link 3L. The right leg link 3R is the same as with the left leg link 3L, so that the description of the right leg link 3R will be omitted.

Referring to FIG. 12, the support force acting on the left leg link 3L from a floor side through the intermediary of the second joint 6 can be regarded as a translational force directed from the second joint 6 toward the curvature center 4a of the guide rail 11, and the desired value of the magnitude of the translational force provides the leg link share desired value Fcmd. Further, if it is assumed that the translational force (support force) of the magnitude of the leg link share desired value Fcmd is applied to the left leg link 3L from the floor side, then the torque that balances a moment generated about the joint axis of the third joint 8 by the vector of the translational force is the basic desired torque Tcmd1 to be determined.

In this case, if a segment that connects the curvature center 4a of the guide rail 11 and the third joint 8 is denoted by S1, a segment that connects the third joint 8 and the second joint 6 is denoted by S2, and a segment that connects the curvature center 4a of the guide rail 11 and the second joint 6 is denoted by S3, as illustrated. Further, the lengths of the segments S1, S2 and S3 are denoted by L1, L2 and L3, respectively, and an angle formed by the segment S2 and the segment S3 is denoted by θ3. A relationship indicated by expression (1) given below is established between the leg link share desired value Fcmd and the basic desired torque Tcmd1.

Tcmd1=(Fcmd·sin θ3)·L2 (1)

The right-hand side of expression (1) indicates the magnitude of the moment generated about the joint axis of the third joint 8 by the vector of a translational force when it is assumed that the translational force (support force) of the magnitude of the leg link share desired value Fcmd is applied to the left leg link 3L from the floor side.

Then, the basic desired torque calculator 64b determines the basic desired torque Tcmd1 according to expression (1) given above. In this case, the value of L2 necessary for calculating the right-hand side of expression (1) is a fixed value that is stored and retained beforehand in a memory (not shown). Further, an angle θ3 is determined by geometric calculation from the length L1 of the segment S1, the length L2 of the segment S2, and the measured value θ1 of the knee angle of the left leg link 3L, which is input. The length L1 of the segment S1 has a fixed value that is stored and retained beforehand in a memory (not shown), as with L2.

To be more specific, in a triangle having the segments S1, S2 and S3 as the three sides thereof, relational expressions (2) and (3) given below hold.

L3²=L1²+L2²−2·L1·L2·cos(180°−θ1) (2)

L1²=L2²+L3²−2·L2·L3·cos θ3 (3)

Thus, L3 can be calculated from the values of L1 and L2 and the measured value θ1 of the knee angle according to expression (2). Then, the angle θ3 can be calculated from the calculated value of L3 and the values of L1 and L2 according to expression (3).

The above has described the processing by the basic desired torque calculator 64b.

The measured value θ1 of the knee angle of the left leg link 3L is input to the crus compensation torque calculator 64c. Then, the crus compensation torque calculator 64c calculates the crus compensation torque Tcor by carrying out the calculation of a model expression (4) given below by using the input measured value θ1.

Tcor=A1·θ1+A2·sgn(ω1)+A3·ω1+A4·β1+A5·sin(θ1/2) (4)

In expression (4), ω1 in the right-hand side denotes a knee angular velocity as the time-dependent change rate (differential value) of the knee angle of the left leg link 3L, β1 denotes a knee angular acceleration as the time-dependent change rate (differential value) of the knee angular velocity ω1, and sgn( ) denotes a sign function, and A1, A2, A3, A4 and A5 denote coefficients of predetermined values.

The first term of the right-hand side of expression (4) is a term for reducing the desired joint torque Tcmd in the stretching direction of the left leg link 3L from the basic desired torque Tcmd1 by the magnitude of torque to be imparted to the third joint 8 by using a spring (not shown) for urging the left leg link 3L in the stretching direction. The second term of the right-hand side means torque to be imparted to the third joint 8 to drive the third joint 8 against a resisting force generated at the third joint 8 due to a force of friction (kinetic friction force) between the thigh frame 5 and the crus frame 7 at the third joint 8 of the left leg link 3L. The third term of the right-hand side means torque to be imparted to the third joint 8 to drive the third joint 8 against a viscous resisting force between the thigh frame 5 and the crus frame 7 at the third joint 8 of the left leg link 3L, i.e., to drive the third joint 8 against the viscous resisting force generated due to the knee angular velocity ω. The fourth term on the right-hand side means torque to be imparted to the third joint 8 to drive the third joint 8 against an inertial force moment generated due to the knee angular acceleration β1, more specifically, the moment of a resisting force generated at the third joint 8 due to an inertial force generated by a motion of a portion of the left leg link 3L closer to the foot-worn unit 2 than to the third joint 8 (a portion composed of the crus frame 7, the second joint 6, and the foot-worn unit 2). The fifth term of the right-hand side means torque to be imparted to the third joint 8 to drive the third joint 8 against the moment of a resisting force generated at the third joint 8 due to a gravitational force acting on the portion of the left leg link 3L that is closer to the foot-worn unit 2 than to the third joint 8 (the portion composed of the crus frame 7, the second joint 6, and the foot-worn unit 2).

Normally, the angle at which the sine function sin( ) should be applied in the fifth term is the angle formed by the segment S2 (the segment connecting the third joint 8 and the second joint 6) in FIG. 12 and the vertical direction (the direction of gravitational force). In the present embodiment, the length of the thigh frame 5 and the length of the crus frame 7 are almost equal, so that the angle formed by the segment S2 and the vertical direction will be approximately half the knee angle of the left leg link 3L measured by the knee angle measurement processor 61. In the present embodiment, therefore, the angle at which the sine function sin( ) is applied in the fifth term has been set to θ1/2. If, however, an acceleration sensor or a clinometer or the like is mounted on the walking assist device A to enable the detection of the inclination angle (the inclination angle of the segment S2) of the crus frame 7 relative to the direction of gravitational force, then the inclination angle is preferably used instead of θ1/2 in the fifth term.

In order to perform the calculation of the right-hand side of expression (4) described above, the crus compensation torque calculator 64c sequentially calculates the value of the knee angular velocity ω1 and the value of the knee angular acceleration β1, which are required for the calculation, from the time series of the measured value θ1 of the knee angle of the left leg link 3L sequentially input from the left knee angle measurement processor 61L. Then, the crus compensation torque calculator 64c performs the calculation of the right-hand side of expression (4) by using the input measured value θ1 (current value) of the knee angle of the left leg link 3L, the calculated value (current value) of the knee angular velocity ω1, and the value (current value) of the knee angular acceleration β1, thereby calculating the crus compensation torque Tcor. The “current value” means the value determined at a current control cycle of the control unit 21.

Supplementarily, the values of the coefficients A1, A2, A3, A4 and A5 used for the calculation of expression (4) are experimentally identified in advance by an identification algorithm that minimizes the square value of the difference between a value of the left-hand side (actually measured value) and a value of the right-hand side (calculated value) of expression (4) and stored and retained in a memory (not shown). The above has described the processing by the crus compensation torque calculator 64c.

Supplementarily, the model expression (4) is an expression based on an assumption that the spring for urging the left leg link 3L in the stretching direction is provided. If the spring is not provided, then the first term of the right-hand side of expression (4) is unnecessary. The second term among the terms of the right-hand side of expression (4) generally takes a relatively small value, as compared with other terms, so the second term may be omitted. Further alternatively, the crus compensation torque Tcor may be determined by a model expression omitting, among the third term, the fourth term and the fifth term of the right-hand side of expression (4), the term that takes a relatively small value, as compared with the remaining terms. For example, if the portion of the left leg link 3L that is closer to the foot-worn unit 2 than to the third joint 8 is sufficiently light, then both or one of the fourth term and the fifth term may be omitted.

After carrying out the processing by the torque converter 64a, the basic desired torque calculator 64b, and the crus compensation torque calculator 64c as described above, the left instructed current determiner 64L carries out the processing by the addition calculator 64d. In this processing, the basic desired torque Tcmd1 and the crus compensation torque Tcor determined by the basic desired torque calculator 64b and the crus compensation torque calculator 64c, respectively, are added up. In other words, the basic desired torque Tcmd1 is corrected by the crus compensation torque Tcor. Thus, the desired joint torque Tcmd (=Tcmd1+Tcor) is calculated.

The desired joint torque Tcmd indicates, in other words, the desired value of the drive torque for the third joint 8 that is required for applying a desired lifting force to the user P from the seat member 1.

The left instructed current determiner 64L further carries out the processing by the subtraction calculator 64e. In this processing, the actual joint torque Tact determined by the torque converter 64a is subtracted from the desired joint torque Tcmd determined by the addition calculator 64d so as to calculate the difference Terr between Tcmd and Tact (=Tcmd−Tact).

Subsequently, the left instructed current determiner 64L carries out the processing by the feedback calculator 64f. At this time, the error Terr is input to the feedback calculator 64f. The feedback calculator 64f calculates the feedback manipulated variable Ifb as a feedback component for the instructed current value Icmd from the input error Terr according to a predetermined feedback control law. As the feedback control law, a PD law (proportional-derivative law), for example, is used. In this case, the result obtained by multiplying the aforesaid error Terr by a predetermined gain Mp (proportional term) and the differential value (derivative term) obtained by multiplying the error Terr by a predetermined gain Md are added to calculate the feedback manipulated variable Ifb.

In the present embodiment, the sensitivity to a change in the lifting force of the seat member 1 in response to a change in the current (change in the output torque) of the electric motor changes according to the knee angle of the left leg link 3L. According to the present embodiment, therefore, the measured value θ1 of the knee angle of the left leg link 3L is also input, in addition to the error Terr, to the feedback calculator 64f. Then, the feedback calculator 64f variably sets the values of the gains Mp and Md of the aforesaid proportional term and the derivative term, respectively, on the basis of the measured value θ1 of the knee angle of the left leg link 3L according to a data table (not shown) prepared beforehand, the data table indicating the relationship between the knee angles and the gains Mp and Md.

Meanwhile, the left instructed current determiner 64L carries out the processing by the feedforward calculator 64g in parallel to the processing by the feedback calculator 64f. In this case, the left share desired value Fcmd determined by the right/left desired share determiner 63 and the measured value θ1 of the knee angle of the left leg link 3L are input to the feedforward calculator 64g.

The feedforward calculator 64g calculates the feedforward manipulated variable Iff as a feedforward component of the instructed current value of the electric motor 15 according to a model expression (5) given below.

Iff=B1−Tcmd1+B2·ω1+B3·sgn(ω1)+B4·β1+B5·θ1 (5)

where Tcmd1 in the right-hand side of expression (5) is the same as the basic desired torque Tcmd1 determined by the basic desired torque calculator 64b, ω1 and β1 denote the knee angular velocity and the knee angular acceleration, respectively, as described in relation to the aforesaid expression (4), and B1, B2, B3, B4 and B5 denote coefficients of predetermined values.

Further, the first term of the right-hand side of expression (5) means a basic required value of the energizing current of the electric motor 15 required to impart drive torque that balances a moment generated about the joint axis of the third joint 8 to the third joint 8 of the left leg link 3L in the case where it is assumed that a drive torque of the basic desired torque Tcmd1, i.e., a support force of the left share desired value Fcmd, is applied to the left leg link 3L from a floor side. The second term of the right-hand side means a component of the energizing current of the electric motor 15 required to impart, to the third joint 8, drive torque against a viscous resisting force between the thigh frame 5 and the crus frame 7 at the third joint 8 of the left leg link 3L, i.e., a viscous resisting force between the thigh frame 5 and the crus frame 7 generated according to the knee angular velocity ω1. The third term of the right-hand side means a component of the energizing current of the electric motor 15 required to impart, to the third joint 8, drive torque against a kinetic friction force between the thigh frame 5 and the crus frame 7 at the third joint 8 of the left leg link 3L. The fourth term of the right-hand side means a component of the energizing current of the electric motor 15 required to impart, to the third joint 8, drive torque against an inertial force moment generated according to the knee angular acceleration β1. The fifth term of the right-hand side is a term for reducing the energizing current of the electric motor 15 generating drive torque in the stretching direction of the left leg link 3L by the magnitude of the torque to be imparted to the third joint 8 by a spring (not shown) that urges the left leg link 3L in the stretching direction.

In this case, the feedforward calculator 64g calculates ω1 and β1 required for calculating the right-hand side of expression (5) from the time series of the measured value θ1 of the knee angle of the left leg link 3L, which is input, as with the case of the processing by the crus compensation torque calculator 64c. Further, the feedforward calculator 64g calculates the basic required torque Tcmd1 necessary to calculate the right-hand side of expression (5) from the left share desired value Fcmd and the measured value θ1 of the knee angle, which are input, by the same arithmetic processing as that performed by the basic desired torque calculator 64b. Then, the feedforward calculator 64g calculates the right-hand side of expression (5) by using the input measured value θ1 (current value) of the knee angle of the left leg link 3L, the calculated value (current value) of the knee angular velocity ω1, the calculated value (current value) of the knee angular acceleration β1, and the calculated value (current value) of the basic desired torque Tcmd1, thereby calculating the feedforward manipulated variable Iff.

Supplementarily, the values of the coefficients B1, B2, B3, B4 and B5 used for the calculation of expression (5) are experimentally identified in advance by an identification algorithm that minimizes the square value of the difference between a value of the left-hand side (actually measured value) and a value of the right-hand side (calculated value) of expression (5) and stored and retained in a memory (not shown). The model expression (5) is an expression based on an assumption that the spring for urging the left leg link 3L in the stretching direction is provided. If the spring is not provided, then the fifth term of the right-hand side of expression (5) is unnecessary. Further, the feedforward manipulated variable Iff may be determined by a model expression in which, for example, the second term or the fourth term is omitted among the terms of the right-hand side of expression (5). Further alternatively, the basic desired torque Tcmd1 calculated by the basic desired torque calculator 64b may be input to the feedforward calculator 64g instead of inputting the leg link share desired value Fcmd thereto. In this case, there is no need to calculate Tcmd1 by the feedforward calculator 64g.

After carrying out the processing by the feedback calculator 64f and the feedforward calculator 64g as described above, the instructed current determiner 64 carries out the processing by the addition calculator 64h. In this processing, the feedback manipulated variable Ifb and the feedforward manipulated variable Iff determined by the feedback calculator 64f and the feedforward calculator 64g, respectively, are added up. Thus, the instructed current value Icmd of the left electric motor 15 is calculated.

The above has described in detail the processing by the left instructed current determiner 64L. The processing by the right instructed current determiner 64R is carried out in the same manner.

The control unit 21 outputs the instructed current values Icmd_R and Icmd_L determined as described above by the instructed current determiners 64R and 64L, respectively, to driver circuits (not shown) corresponding to the electric motors 15 of the leg links 3R and 3L. At this time, the driver circuits energize the electric motors 15 on the basis of the supplied instructed current values Icmd. Thus, the rotational actuators 9 of the leg links 3R and 3L are driven and the walking assist device A imparts an upward translational force as the assist force to the body trunk of the user P.

As described above, according to the present embodiment, if there is a difference in the SOC between the battery 19 of the leg link 3R and the battery 19 of the leg link 3L, i.e., if the difference in the remaining amount of charge SOC_d is not zero, then the manipulated variable H of the distribution ratio map is changed by the processing carried out by the right/left desired share determiner 63 of the control unit 21 such that the drive force of the rotational actuator 9 having the battery 19 with a lower SOC is smaller and the drive force of the rotational actuator 9 having the battery 19 with a higher SOC is larger, as compared with the drive forces of the rotational actuators 9 in the case where the SOCs of the batteries 19 are the same, i.e., the difference in the remaining amount of charge SOC_d is zero, thus controlling the rotational actuators 9 according to the updated manipulated variable H of the distribution ratio map.

With the processing, the drive forces of the rotational actuators 9 are controlled to reduce the difference in the SOC of the batteries 19, namely, the difference in the remaining amount of charge SOC_d. Hence, when the SOC of either one of the batteries 19 (e.g., the battery 19 of the left leg link 3L) reaches zero (or a value near zero), the other battery 19 (e.g., the battery 19 of the right leg link 3R) also reaches zero (or a value near zero). Thus, the walking assist device A of the present embodiment, which has a plurality of (two) batteries 19 for the right leg link 3R and the left leg link 3L, is capable of reducing variations in the SOCs of the batteries 19 and therefore capable of restraining a reduction in the operating time of the walking assist device A.

In the present embodiment, the control unit 21 is housed in the support frame 1b of the seat member 1, and the output signals of the sensors 11aL, 11aR, 22a and 22b of both the leg links 3R and 3L are input to the control unit 21; however, the present invention is not limited thereto. For example, a control unit may be disposed in each of the right and left leg links 3R and 3L, and the leg spread angle θ2, the SOC and the measured tread force Fft_R (Fft_L) may be transferred between the control units thereby to determine the leg link share desired value Fcmd_R (Fcmd_L) independently for each of the leg links 3R and 3L.

In this case, the same program, data, table and the like may be stored and retained beforehand in the memory of the control unit of each of the leg links 3L and 3R, and the leg link (3L or 3R) on which itself (the control unit) is mounted may be defined as its own leg and the leg link (3R or 3L) on which itself (the control unit) is not mounted may be defined as the other leg in carrying out the processing described in the present embodiment, defining the left leg as its own leg and the right leg as the other leg. Thus, each of the control units may determine the share ratio, the leg link share desired value and the instructed current value on its own leg. In this case also, the leg link share desired value based on the SOC of each battery is obtained, as with the present embodiment.

Further, the present embodiment has been described by taking, as an example, the walking assist device A, which is adapted to impart an upward translational force as the assist force to the body trunk of the user P; however, the motion assist device in accordance with the present invention is not limited thereto. The present invention can be applied to any motion assist device as long as it is adapted to assist a motion such that the operating points of a plurality of actuators lies on the same portion of the user P.

For example, the present invention can be applied to a motion assist device adapted to impart an assist force (translational force or moment) for assisting a motion of an arm of the user P. Further, actuators provided in the motion assist device or a walking assist device are not limited to the rotary type and may alternatively be a directly operated type.

Further, according to the present embodiment, the distribution ratio map applied when there is a difference between the SOCs of the batteries 19 of the leg links 3R and 3L is set as illustrated in FIGS. 8A and 8B. More specifically, the left share ratio Ratio_L is set such that the right/left tread force ratio is denoted by a straight line in a zone from 0 to α1 and the right/left tread force ratio is denoted by a straight line in a zone from α1 to 1. The right share ratio Ratio_R is set such that the right/left tread force ratio is denoted by a straight line in a zone from 0 to α2 and the right/left tread force ratio is denoted by a straight line in a zone from α2 to 1.

However, the distribution ratio map is not limited to the one described above, and other types of distribution ratio map may be used as long as the map is set such that the total of the right share desired value Fcmd_R and the left share desired value Fcmd_L corresponding to a predetermined right/left tread force ratio always becomes 1, and if there is a difference in the SOC between the batteries 19 of the leg links 3R and 3L, then the drive force of the rotational actuator 9 of the leg link (3R or 3L) having the battery 19 with a lower SOC is smaller, while the drive force of the rotational actuator 9 of the leg link (3L or 3R) having the battery 19 with a higher SOC is larger, as compared with the drive forces of the rotational actuators 9 of the leg links 3R and 3L in the case where the SOCs thereof are equal.

For example, the distribution ratio map may be the distribution ratio maps as shown in. FIG. 13A illustrates a case where the left detected remaining amount of charge SOC_L is larger than the right detected remaining amount of charge SOC_R, while FIG. 13B illustrates a case where the left detected remaining amount of charge SOC_L is smaller than the right detected remaining amount of charge SOC_R.

In a case where the left detected remaining amount of charge SOC_L is larger than the right detected remaining amount of charge SOC_R, then the case is denoted by a curve projecting upward, in which the left share ratio Ratio_L becomes 1 when the right/left tread force ratio is 0, becomes 0.5 when the right/left tread force ratio is α1, and becomes 0 when the right/left tread force ratio is 1, and denoted by a curve projecting downward, in which the right share ratio Ratio_R becomes 0 when the right/left tread force ratio is 0, becomes 0.5 when the right/left tread force ratio is α1, and becomes 1 when the right/left tread force ratio is 1 (FIG. 13A).

In a case where the left detected remaining amount of charge SOC_L is smaller than the right detected remaining amount of charge SOC_R, then the case is denoted by a curve projecting downward, in which the left share ratio Ratio_L becomes 1 when the right/left tread force ratio is 0, becomes 0.5 when the right/left tread force ratio is α2, and becomes 0 when the right/left tread force ratio is 1, and denoted by a curve projecting upward, in which the right share ratio Ratio_R becomes 0 when the right/left tread force ratio is 0, becomes 0.5 when the right/left tread force ratio is α2, and becomes 1 when the right/left tread force ratio is 1 (FIG. 13B).

The distribution ratio maps in FIGS. 13A and 13B are set such that the total of the right share desired value Fcmd_R and the left share desired value Fcmd_L corresponding to a predetermined right/left tread force ratio always becomes 1.

In addition to the distribution ratio maps in FIGS. 13A and 13B, a distribution ratio map shown in FIGS. 14A and 14B may be used. FIG. 14A illustrates a case where the left detected remaining amount of charge SOC_L is larger than the right detected remaining amount of charge SOC_R, while FIG. 14B illustrates a case where the left detected remaining amount of charge SOC_L is smaller than the right detected remaining amount of charge SOC_R.

If the left detected remaining amount of charge SOC_L is larger than the right detected remaining amount of charge SOC_R, then the left share ratio Ratio_L is denoted by a straight line on which 1 is reached in a zone of the right/left tread force ratio from 0 to a predetermined right/left tread force ratio α3 (where α3<0.5) and by a straight line on which 1 is reached when the right/left tread force ratio is α3, 0.5 is reached when the right/left tread force ratio is α1, and 0 is reached when the predetermined right/left tread force ratio 1 in a zone of the right/left tread force ratio from α3 to 1, while the right share ratio Ratio_R is denoted by a straight line on which 0 is reached in a zone of the right/left tread force ratio from 0 to a predetermined right/left tread force ratio α3 and by a straight line on which 0 is reached when the right/left tread force ratio is α3, 0.5 is reached when the right/left tread force ratio is α1, and 1 is reached when the predetermined right/left tread force ratio 1 in a zone of the right/left tread force ratio from α3 to 1 (FIG. 14A).

If the left detected remaining amount of charge SOC_L is smaller than the right detected remaining amount of charge SOC_R, then the left share ratio Ratio_L is denoted by a straight line on which 1 is reached when the right/left tread force ratio is 0, 0.5 is reached when the right/left tread force ratio is α2, and 0 is reached the right/left tread force ratio is α4 in a zone of the right/left tread force ratio from 0 to a predetermined right/left tread force ratio α4 (where α4>0.5) and by a straight line on which 0 is reached in a zone of the right/left tread force ratio from α4 to 1, while the right share ratio Ratio_R is denoted by a straight line on which 0 is reached when the right/left tread force ratio is 0, 0.5 is reached when the right/left tread force ratio is α2, and 1 is reached the right/left tread force ratio is α4 in a zone of the right/left tread force ratio from 0 to a predetermined right/left tread force ratio α4 (where α4>0.5) and by a straight line on which 1 is reached in a zone of the right/left tread force ratio from α4 to 1 (FIG. 14B).

FIGS. 14A and 14B are set such that the total of the left share desired value Fcmd_L and the right share desired value Fcmd_R corresponding to a predetermined right/left tread force ratio is always 1.

In the case where the distribution ratio maps shown in FIGS. 13A, 13B, 14A, and 14B, the same advantage as that in the case where the distribution ratio map shown in FIGS. 8A and 8B used in the present embodiment is applied can be also obtained. More specifically, even when a plurality of (two) batteries 19 is used, the difference in the SOC between the batteries 19 is easily reduced, thus making it possible to restrain a reduction in the operating time of the walking assist device A.

Further, in the present embodiment, the distribution ratio map is determined on the basis of the manipulated variable H, but the present invention is not limited thereto. For example, a difference D in the share ratio when the right/left tread force ratio is 0.5 may be determined.

In the present embodiment, the distribution ratio map is determined by the calculation described above. Alternatively, however, a plurality of distribution ratio maps may be prepared and stored and retained in a memory (not shown) beforehand, then one distribution ratio map may be selected on the basis of the difference in the remaining amount of charge SOC_d.

In the present embodiment, the flowchart shown in FIG. 9 has been presented as an example of the processing by the right/left desired share determiner 63; however, the processing is not limited thereto. For example, one or a plurality steps of step ST2, step ST4, and step ST5 may be removed from the flowchart of FIG. 9 or all of steps ST2, ST4 and ST5 may be removed, i.e., the processing of a flowchart consisting of only steps ST1, 3, 6 and 7 may be carried out. This also provides the advantage of the present invention that the variations in the SOCs of a plurality of the batteries 19 are decreased, making it possible to restrain a reduction in the operating time of the walking assist device A.

Further, in the present embodiment, the PID control is used in step ST3. Alternatively, however, any other control, such as P control, PD control or PI control, may be used.

What is claimed is:

1. A motion assist device for assisting a user with his/her motions, comprising:
a plurality of drivers configured to generate forces for assisting a motion of a user;
a plurality of energy sources that supplies energy to the plurality of the drivers;
a remaining amount detector configured to detect an energy remaining amount of each of the energy sources; and
a controller configured to control the plurality of the drivers on the basis of a detection result of the remaining amount detector,
wherein the plurality of the drivers is configured such that an operating point of each generated force lies in the same part of the user,
and in the case where one or a plurality of drivers to which energy is supplied from the same energy source among the plurality of the drivers constitute one drive source, and an output or outputs of one or a plurality of the drivers belonging to the drive source are defined as an output of the drive source,
the controller controls the plurality of the drivers, in the case where there is a difference in the energy remaining amount among the energy sources, such that the drive source corresponding to an energy source having a small energy remaining amount generates a smaller output than an output of the drive source in the case where the energy remaining amounts of the energy sources are equal, while the driver source corresponding to an energy source having a large energy remaining amount generates a larger output than an output of the drive source in the case where the energy remaining amounts of the energy sources are equal.

2. A walking assist device comprising:
a seat member on which a user sits astride;
a plurality of leg links connected to the seat member; and
a driver configured to be capable of driving the leg links in a direction for pushing the seat member up, at least a part of the weight of the user being supported by the leg links through the intermediary of the seat member,
wherein the walking assist device includes a plurality of drivers, each of the drivers driving a single or two or more of the plurality of the leg links,
a plurality of batteries which supplies electric energy to a single or two or more of the plurality of the drivers;
a remaining amount detector configured to detect a remaining amount of charge of each battery; and
a controller configured to control the plurality of the drivers on the basis of a detection result of the remaining amount detector, and
in the case where one or a plurality of the drivers to which electric energy is supplied from the same battery among the plurality of the drivers constitutes one drive source, and an output or outputs of one or a plurality of the drivers belonging to the drive source are defined as an output or outputs of the drive source,
the controller controls the plurality of the drivers, in the case where there is a difference in the remaining amount of charge among the batteries, such that the drive source corresponding to a battery having a small remaining amount of charge generates a smaller output than an output of the drive source in the case where the remaining amounts of charge of the batteries are equal, while the driver source corresponding to a battery having a large remaining amount of charge generates a larger output than an output of the drive source in the case where the remaining amounts of charge of the batteries are equal.

3. The walking assist device according to claim 2, wherein, as the difference in the remaining amount of charge between predetermined two batteries among the plurality of the batteries increases, the controller controls the two drive sources corresponding to the predetermined two batteries such that the difference in electric energy supplied to the two drive sources increases.

4. The walking assist device according to claim 2, wherein, as a state in which there is a difference in the remaining amount of charge between predetermined two batteries among the plurality of the batteries lasts longer, the controller controls the two drive sources corresponding to the predetermined two batteries such that the difference in the electric energy supplied to the two drive sources increases.

5. The walking assist device according to claim 2, wherein, as a time-dependent change amount of a difference in the remaining amount of charge between predetermined two batteries among the plurality of the batteries increases, the controller controls the two drive sources corresponding to the predetermined two batteries such that the difference in the electric energy supplied to the two drive sources increases.

6. The walking assist device according to claim 2,
wherein, in the case where one or a plurality of the drivers corresponding to the drive source drives one or the plurality of the leg links and in the case where a force by which each leg link pushes the seat member up or a force combining individual forces is defined as a leg link resultant force,
the controller controls predetermined two drive sources among the plurality of the drive sources such that the difference in the electric energy supplied to the predetermined two drive sources decreases as an angle formed by the individual leg link resultant forces increases.

7. The walking assist device according to claim 2, wherein, in the case where the difference in the remaining amount of charge of predetermined two batteries among the plurality of the batteries is a predetermined value or more, the controller controls the plurality of drivers on the basis of a detection result of the remaining amount detector.
